(19) United States
(12) Patent Application Publication
(10) Pub. No.: US 2019/0197499 A1
(43) Pub. Date: Jun. 27, 2019

(54) Computer System and Computer-Implemented Method for Issuing a Deposit Code as a Substitute for Cash

(71) Applicant: MASTERCARD ASIA/PACIFIC PTE. LTD., Singapore (SG)

(72) Inventors: Hui Fang, Sembawang (SG); Yufeng Xing, Singapore (SG); Sunitha Miryala, Edgedale Plains (SG); Bo Zeng, Singapore (SG)

(21) Appl. No.: 16/220,430

(22) Filed: Dec. 14, 2018

(30) Foreign Application Priority Data
Dec. 21, 2017 (SG) 10201710685R

(51) Int. Cl. G06Q 20/08; G06Q 20/22; G06Q 20/40; G06Q 20/36

(52) U.S. Cl. CPC G06Q 20/08; G06Q 20/36; G06Q 20/401; G06Q 20/22

(57) ABSTRACT

A computer system for issuing a deposit code as a substitute for cash is described. The computer system includes at least one merchant apparatus, a deposit code database, and a deposit server. Each merchant apparatus is being configured to receive, from a customer or a merchant, at least one of the cash deposit or a deposit amount indicating an equivalent monetary value of the cash deposit, and transmit, a deposit request, the deposit request including the deposit amount and a merchant identifier, the merchant identifier indicating at least a merchant account associated with the merchant apparatus. The deposit code database is configured to store deposit code information associated with multiple such deposit requests, the deposit code information including a deposit identifier, the deposit amount and the merchant identifier.

### CROSS REFERENCE TO RELATED APPLICATIONS

This patent application claims priority to Singapore Patent Application No. 10201710685R filed on Dec. 21, 2017, the disclosure of which is incorporated by reference herein in its entirety as part of the present application.

### BACKGROUND

The present disclosure relates to a computer system and computer-implemented method for issuing a deposit code as a substitute for cash.

Despite the proliferation of cashless payment options in recent years, cash remains as a ubiquitous form of payment in present economies. Use of cash payment is especially prevalent among elderly customers who remain insecure in utilizing non-physical forms of payment. Cash payment is also a popular payment option in developing and/or under-developed countries where forms of cashless payment are less accessible and developed.

Though cash as a payment vehicle is easy to use (for example it does not require pre-registration), it nonetheless exists in small denominations (such as coins) which may cause inconveniences to customers and merchants alike. For example, customers may find it onerous to carry coins around in a wallet/purse, while it may be costly and bothersome for merchants to maintain sufficient coins for their businesses to provide change to customers and/or to deposit coins in financial institutions. In addition, options of using coins may also be limited. For example, customers may use coins in vending machines but only for purchasing specific products; while depositing coins in a bank expends time, resources and effort for customers.

It is therefore an aim of the present disclosure to provide a computer system and computer-implemented method to address these and other problems with making cash payments.

### BRIEF DESCRIPTION

A first aspect of the present disclosure provides a computer system for issuing a deposit code as a substitute for cash. The computer system includes at least one merchant apparatus, each merchant apparatus being configured to receive, from a customer or a merchant, at least one of a cash deposit or a deposit amount indicating an equivalent monetary value of the cash deposit, and transmit, a deposit request, the deposit request including the deposit amount and a merchant identifier, the merchant identifier indicating at least a merchant account associated with the merchant apparatus, a deposit code database configured to store deposit code information associated with multiple such deposit requests, the deposit code information including a deposit identifier, the deposit amount and the merchant identifier, and a deposit server configured to receive the deposit request, generate a deposit code associated with the deposit request, wherein the deposit code includes at least the deposit identifier associated with the deposit request, store, in the deposit code database, the deposit code information associated with the deposit code, and transmit, to the merchant apparatus, the deposit code for exchange with a customer in lieu of the cash deposit.

Embodiments of the disclosure therefore provide a computer system that can be used for issuing a deposit code as a substitute for cash. In particular, the computer system of the present disclosure includes a merchant apparatus which is configured to receive at least one of the cash deposit or deposit amount from a customer or a merchant, and indicates an equivalent monetary value of the cash deposit. The merchant apparatus communicates with a deposit server to transmit a deposit request including the deposit amount and a merchant identifier associated with the merchant apparatus. The merchant identifier may include a name of the merchant and/or an account number associated with the merchant account. The deposit server receives the deposit request and generates a deposit code including at least a deposit identifier associated with the deposit request. The deposit identifier is an identifier which can uniquely identify the deposit request and may include a portion or a string of numerals and/or alphanumeric or symbols in any combination. The server also stores deposit code information including the deposit identifier, the deposit amount and the merchant identifier in a deposit code database associated with the deposit server. In embodiments, the deposit identifier is used to retrieve associated deposit code information (e.g. the deposit amount and the merchant identifier) when the deposit code is read at the merchant apparatus or at a customer electronic device associated with the customer. The deposit code may also include the deposit identifier and the deposit amount, or the deposit identifier and the merchant identifier. In embodiments, the deposit code may include the deposit identifier, the deposit amount and the merchant identifier. The deposit code may include the merchant identifier and the deposit amount. The deposit code is then transmitted to the merchant apparatus which is presented to the customer in exchange for the cash deposit.

The present disclosure provides a substitute for cash, which may be in the form of deposit codes which are easier for customers to carry around. The deposit codes may be issued in physical form (e.g. in a printed receipt) and/or in digital form which can be stored in customer electronic devices, therefore they are more secure and less susceptible to lost (e.g. compared to loose coins which can be easily misplaced). Moreover, the deposit codes can be used in appropriate applications (mobile or otherwise) so that the deposit amount can be refunded to customer accounts electronically (see e.g. FIG. 3 for more detail) or transferred to other accounts (e.g. to make further payments). Since the deposit code can be transferred and/or stored in electronic wallets, customers can use the deposit code to support sharing a bill or can transfer an equivalent value of the deposit amount to another account electronically. The use of the deposit code can also improve customer experience as customers do not need to either be mindful of using coins in future transactions so as to reduce the amount of cash they hold in coin denominations or to queue in banks to deposit coins.

From the view point of a merchant, the conversion of a small denomination of cash into a deposit code is also desirable. For example, the use of a deposit code reduces the use of coins and the need to maintain a stock of change, thereby making cash transactions more convenient and improving safety and security for day-to-day operations of the merchant. Deposit codes generated in place of small denominations of cash can be more easily tracked and balanced, thereby reducing time and effort for the merchant in keeping track of these small denominations of cash. Moreover, cumulative small denominations of cash deposited at the merchant are retained with the merchant until they are withdrawn by the customers (e.g. either by deposition of a deposit code or through use in payment transactions). This provides the merchant with more flexibility in his/her cash flow.

The at least one merchant apparatus includes an input/output module configured to receive at least one of the cash deposit or deposit amount indicating an equivalent monetary value of the cash deposit, and present, to a customer, the deposit code in exchange for the cash deposit, and at least one apparatus processor configured to calculate the deposit amount indicating an equivalent monetary value of the cash deposit when such cash deposit is received, transmit, to the deposit server, a deposit request including the deposit amount and a merchant identifier, the merchant identifier indicating at least a merchant account associated with the merchant apparatus, and receive, from the deposit server, a deposit code associated with the deposit request, wherein the deposit code includes at least a deposit identifier associated with the deposit request.

The input/output module may be configured to receive an input deposit code and instructions to split the input deposit code into a plurality of deposit codes, each of smaller value than the input deposit code, and present, to the customer, the plurality of deposit codes, and the at least one apparatus processor may be configured to retrieve, from the input deposit code, at least an input deposit amount and an input merchant identifier associated with the input deposit code, split the input deposit amount into a plurality of deposit amounts having the smaller values, wherein the smaller values together add up to the input deposit amount, and generate the plurality of deposit codes, wherein each of the plurality of deposit codes is associated with each of the plurality of deposit amounts and at least the input merchant identifier.

The input/output module may be configured to receive an input deposit code, and instructions to split the input deposit code into a plurality of deposit codes, each of smaller value than the input deposit code, and present, to the customer, the plurality of deposit codes, and the at least one apparatus processor may be configured to transmit, to the deposit server, a split request including the input deposit code, and instructions to split the input deposit code into a plurality of deposit amounts having smaller values, together adding up to a value of the input deposit code, and receive, from the deposit server, a split response including the plurality of deposit codes, wherein each of the plurality of deposit codes is associated with each of the plurality of deposit amounts, and at least a split identifier associated with the split request.

The input/output module may be configured to receive a plurality of deposit codes, and present, to the customer, an aggregated deposit code, and the at least one apparatus processor may be configured to transmit, to the deposit server, an aggregation request including the plurality of deposit codes, the aggregation request being a request to consolidate a plurality of deposit amounts associated with the plurality of deposit codes, and receive, from the deposit server, an aggregation response including an aggregated deposit code, wherein the aggregated deposit code is associated with a total sum of the plurality of deposit amounts and at least an aggregation identifier associated with the aggregation request.

The at least one merchant apparatus may include a printing module, wherein the at least one apparatus processor is further configured to generate, together with the printing module, physical forms of the deposit code, the plurality of deposit codes having smaller values and/or the aggregated deposit code.

The at least one merchant apparatus may be incorporated into one of the following: a vending machine, an automated teller machine (ATM), and a point-of-sale (POS) terminal.

A second aspect of the present disclosure provides a deposit server for issuing a deposit code as a substitute for cash, the deposit server includes a processor configured to receive, from a merchant apparatus, a deposit request, the deposit request including a deposit amount and a merchant identifier, the merchant identifier indicating at least a merchant account associated with a merchant, generate a deposit code associated with the deposit request, wherein the deposit code includes at least a deposit identifier associated with the deposit request, create and store deposit code information associated with the deposit request and the deposit code, the deposit code information including the deposit identifier, the deposit amount and the merchant identifier, wherein the deposit code information is stored in a deposit code database, and transmit a deposit response to the merchant apparatus wherein the deposit response includes at least the deposit code.

The deposit server may be configured to receive, from a customer electronic device associated with a customer, a deposition request associated with a deposition transaction, the deposition request including the deposit code and a customer identifier associated with the customer, query the deposit code database to identify at least the deposit amount and the merchant identifier, request authorization from an acquirer server associated with the merchant identifier to proceed with the deposition transaction, wherein the deposition transaction includes transferring funds equal to the deposit amount associated with the deposit code from the merchant account to a customer account associated with the customer identifier, and transmit, to the customer electronic device, a deposition response indicating an approval or a refusal for the deposition transaction.

The deposit server may be configured to receive a split request including an input deposit code, and instructions to split the input deposit code into a plurality of deposit codes, each of smaller value than the input deposit code, query the deposit code database to identify at least an input deposit amount and an input merchant identifier associated with the input deposit code, split the input deposit amount into a plurality of deposit amounts having the smaller values, wherein the smaller values together add up to the input deposit amount, and generate the plurality of deposit codes, wherein each of the plurality of deposit codes is associated with each of the plurality of deposit amounts and at least a split identifier associated with the split request, and transmit a split response including the plurality of deposit codes having the smaller values.

The deposit server may be configured to receive an aggregation request including a plurality of deposit codes, query the deposit code database to identify at least the deposit amount and the merchant identifier associated with each of the plurality of deposit codes, consolidate an aggregated deposit amount equivalent to a sum of the deposit amounts associated with the plurality of deposit codes, and generate an aggregated deposit code, wherein the aggregated deposit code includes at least an aggregation deposit identifier associated with the aggregation request and associated with the aggregated deposit amount, and transmit an aggregation response including the aggregated deposit code.

The deposit server may be configured to receive a payment transaction request including at least one deposit code, a receiver account identifier and a transaction amount, wherein the receiver account identifier identifies a receiver account associated with a receiver of the payment transaction, query the deposit code database to identify at least one deposit amount and at least one merchant identifier associated with the at least one deposit code, sort the at least one deposit code according to the at least one deposit amount associated with the at least one deposit code, determine if a largest deposit amount associated with the at least one deposit code is greater than or equal to the transaction amount, calculate a transacted deposit amount if the largest deposit amount is greater than or equal to the transaction amount, the transacted deposit amount being the largest deposit amount subtracting the transaction amount, and generate a transacted deposit code, wherein the transacted deposit code stores at least a payment transaction identifier associated with the payment transaction request and the transacted deposit amount, request authorization to proceed with the payment transaction, wherein the payment transaction includes transferring funds equal to the transaction amount from the merchant account associated with the at least one deposit code to the receiver account, and transmit a payment transaction response including a result of the payment transaction request and the transacted deposit code.

Where the largest deposit amount is less than the transaction amount, the deposit server may be configured to determine if a sum of the largest deposit amount and a second largest deposit amount associated with the at least one deposit code is greater than or equal to the transaction amount, calculate a new transacted deposit amount if the at least one deposit amount is greater than or equal to the transaction amount, the new transacted deposit amount being the sum of the largest and the second largest deposit amounts subtracting the transaction amount, and generate a new transacted deposit code, wherein the new transacted deposit code stores at least a payment transaction identifier associated with the payment transaction request and the new transacted deposit amount, wherein the payment transaction response includes the new transacted deposit code.

The deposit server may be configured to receive a payment transaction request including at least one deposit code, a receiver account identifier and a transaction amount, wherein the receiver account identifier identifies a receiver account associated with a receiver of the payment transaction, query the deposit code database to identify at least one deposit amount and at least one merchant identifier associated with the at least one deposit code, sort the at least one deposit code according to the at least one deposit amount associated with the at least one deposit code, determine a sum of the at least one deposit amount such that a largest number of the at least one deposit codes associated with the at least one deposit amount is required for the sum to be greater than or equal to the transaction amount, calculate a transacted deposit amount, the transacted deposit amount being the sum of the at least one deposit amount subtracting the transaction amount, and generate a transacted deposit code, wherein the transacted deposit code stores at least a payment transaction identifier associated with the payment transaction request and the transacted deposit amount, and request authorization to proceed with the payment transaction, wherein the payment transaction includes transferring funds equal to the transaction amount from the merchant account associated with the at least one deposit code to the receiver account, and transmit a payment transaction response including a result of the payment transaction request and the transacted deposit code.

A third aspect of the present disclosure provides a computer-implemented method for issuing a deposit code as a substitute for cash. The method includes receiving, from a merchant apparatus, a deposit request, the deposit request including a deposit amount and a merchant identifier, the merchant identifier indicating at least a merchant account associated with a merchant, generating a deposit code associated with the deposit request, wherein the deposit code includes at least a deposit identifier associated with the deposit request, creating and storing deposit code information associated with the deposit request and the deposit code, the deposit code information including the deposit identifier, the deposit amount and the merchant identifier, wherein the deposit code information is stored in a deposit code database, and transmitting, to the merchant apparatus, a deposit response, the deposit response including at least the deposit code for exchange with a customer in lieu of the cash deposit.

The method may include receiving, from a customer electronic device associated with a customer, a deposition request associated with a deposition transaction, the deposition request including the deposit code and a customer identifier associated with the customer, querying the deposit code database to identify at least the deposit amount and the merchant identifier, requesting authorization, from an acquirer server associated with the merchant account, to proceed with the deposition transaction, wherein the deposition transaction includes transferring funds equal to the deposit amount associated with the deposit code from the merchant account to a customer account associated with the customer identifier, and transmitting, to the customer electronic device, a deposition response indicating an approval or a refusal for the deposition transaction.

The method may include receiving, from the merchant apparatus, a split request including an input deposit code and instructions to split the input deposit code into smaller values, querying the deposit code database to identify at least an input deposit amount and an input merchant identifier associated with the input deposit code, splitting the input deposit amount into a plurality of deposit amounts having the smaller values, wherein the smaller values together add up to the input deposit amount, generating a plurality of deposit codes, wherein each of the plurality of deposit codes is associated with each of the plurality of deposit amounts and includes at least a split identifier associated with the split request, and transmitting, to the merchant apparatus, a split response including the plurality of deposit codes having the smaller values.

The method may include receiving, from the merchant apparatus, an aggregation request including a plurality of deposit codes, querying the deposit code database to identify at least the deposit amount and the merchant identifier associated with each of the plurality of deposit codes, consolidating an aggregated deposit amount equivalent to a sum of the deposit amounts associated with the plurality of deposit codes, generating an aggregated deposit code, wherein the aggregated deposit code stores at least an aggregation deposit identifier associated with the aggregation request and is associated with the aggregated deposit amount, and transmitting, to the merchant apparatus, an aggregation response including the aggregated deposit code.

The method may include receiving, from the merchant apparatus, a payment transaction request including at least one deposit code, a receiver account identifier, and a transaction amount, wherein the receiver account identifier identifies a receiver account associated with a receiver of the payment transaction, querying the deposit code database to identify at least one deposit amount and at least one merchant identifier associated with the at least one deposit code, sorting the at least one deposit code according to the at least one deposit amount associated with the at least one deposit code, determining if a largest deposit amount associated with the at least one deposit code is greater than or equal to the transaction amount, calculating a transacted deposit amount if the largest deposit amount is greater than or equal to the transaction amount, the transacted deposit amount being the largest deposit amount subtracting the transaction amount, generating a transacted deposit code, wherein the transacted deposit code includes at least a payment transaction identifier associated with the payment transaction request and the transacted deposit amount, requesting authorization to proceed with the payment transaction, wherein the payment transaction includes transferring funds equal to the transaction amount from the merchant account associated with the at least one deposit code to the receiver account, and transmitting, to the merchant apparatus, a payment transaction response including the transacted deposit code.

Where the largest deposit amount is less than the transaction amount, the method further includes determining if a sum of the largest deposit amount and a second largest deposit amount associated with the at least one deposit code is greater than or equal to the transaction amount, calculating a new transacted deposit amount if the at least one deposit amount is greater than or equal to the transaction amount, the new transacted deposit amount being the sum of the largest and the second largest deposit amounts subtracting the transaction amount, and generating a new transacted deposit code, wherein the new transacted deposit code includes at least a payment transaction identifier associated with the payment transaction request and the new transacted deposit amount, wherein the payment transaction response includes the new transacted deposit code.

The method may include receiving a payment transaction request including at least one deposit code, a receiver account identifier, and a transaction amount, wherein the receiver account identifier identifies a receiver account associated with a receiver of the payment transaction, querying the deposit code database to identify at least one deposit amount and at least one merchant identifier associated with the at least one deposit code, sorting the at least one deposit code according to the at least one deposit amount associated with the at least one deposit code, determining a sum of the at least one deposit amount such that a largest number of the at least one deposit codes associated with the at least one deposit amount is required for the sum to be greater than or equal to the transaction amount, calculating a transacted deposit amount, the transacted deposit amount being the sum of the at least one deposit amount subtracting the transaction amount, generating a transacted deposit code, wherein the transacted deposit code includes at least a payment transaction identifier associated with the payment transaction request and the transacted deposit amount, requesting authorization to proceed with the payment transaction, wherein the payment transaction includes transferring funds equal to the transaction amount from the merchant account associated with the at least one deposit code to the receiver account, and transmitting a payment transaction response including the transacted deposit code.

The cash deposit may include any one or a mixture of currencies.

The deposit code may include, but is not limited to, a Quick Response (QR) code, a barcode, an EZcode, a high capacity color barcode, a ShotCode, a MaxiCode, a GTIN12 code, a GTIN-13 code, or an Aztec code.

A fourth aspect of the present disclosure provides a non-transitory computer-readable medium having stored thereon program instructions for causing at least one processor to perform the preceding method.

The present disclosure aims to provide a new and useful computer system and computer-implemented method for issuing a deposit code as a substitute for cash.

### BRIEF DESCRIPTION OF THE DRAWINGS

Non-limiting embodiments of the disclosure will now be described for the sake of example only, with reference to the following drawings in which:

FIG. 1 shows a computer system in accordance with an embodiment of the disclosure;

FIG. 2 shows steps of a computer-implemented method which may be performed by a deposit server in accordance with an embodiment of the disclosure;

FIG. 3 shows steps of a computer-implemented method for depositing a deposit code in accordance with an embodiment of the disclosure;

FIG. 4 shows steps of a computer-implemented method for splitting a deposit code in accordance with an embodiment of the disclosure;

FIG. 5 shows steps of a computer-implemented method for aggregating a plurality of deposit codes in accordance with an embodiment of the disclosure;

FIG. 6 shows a computer system in accordance with an embodiment of the disclosure for aggregating a plurality of deposit codes;

FIG. 7 shows steps of a computer-implemented method for processing a payment transaction using a deposit code in accordance with an embodiment of the disclosure;

FIG. 8 shows additional steps of the computer-implemented method of FIG. 7 for processing a payment transaction using a deposit code in accordance with an embodiment of the disclosure;

FIG. 9 shows steps of a computer-implemented method for processing a payment transaction using a deposit code in accordance with an embodiment of the disclosure;

FIG. 10 shows steps of a method for making a deposit of a small denomination of cash and for requesting deposition of a deposit code in accordance with an embodiment of the disclosure;

FIG. 11 shows steps of a method for performing a payment transaction using a deposit code in accordance with an embodiment of the disclosure;

FIGS. 12A and 12B depict illustrations of a physical copy of a receipt including a deposit code, where FIG. 12A shows a front side of the receipt and FIG. 12B shows a back side of the receipt including the deposit code;

FIG. 13 shows schematically a functional structure of a deposit server which may be used in the computer system as shown in FIG. 1 in accordance with an embodiment of the disclosure;

FIG. 14 shows schematically a hardware structure of a deposit server which may be used in the computer system of FIG. 1 to implement a method in accordance with an embodiment of the disclosure; and

FIG. 15 shows schematically a functional structure of a merchant apparatus which may be used in the computer system as shown in FIG. 1 in accordance with an embodiment of the disclosure.

### DETAILED DESCRIPTION

As used in this document, the term “electronic wallet” refers to any electronic cashless payment vehicle associated with a payment account, such as a credit card, a debit card, a prepaid card, a charge card, a membership card, a promotional card, a frequent flyer card, an identification card, a prepaid card, a gift card, and/or any other payment device that may hold payment account information, such as mobile phones, Smartphones, personal digital assistants (PDAs), key fobs, transponder devices, near field communication (NFC)-enabled devices, and/or computers.

Note that the term “institution” is used here in a sense which is not necessarily limited to organizations which are legally constituted as banks, since in some jurisdictions other organizations may be permitted to maintain financial accounts such as a payment card account. An institution may be one of the following: a bank, a financial technology company, a telecommunication company, or a financial institution.

As used in this application, the terms “component,” “module,” “system,” “apparatus,” “interface,” or the like are generally intended to refer to a computer-related entity, either hardware, a combination of hardware and software, software, or software in execution. For example, a component or a module may be, but is not limited to being, a process running on a processor, a processor, an object, an executable, a thread of execution, a program, and/or a computer. By way of illustration, both an application running on a controller and the controller can be a component/module. One or more components/modules may reside within a process and/or thread of execution and a component/module may be localized on one computer and/or distributed between two or more computers.

Furthermore, the claimed subject matter may be implemented as a method, an apparatus, or an article of manufacture using standard programming and/or engineering techniques to produce software, firmware, hardware, or any combination thereof to control a computer to implement the disclosed subject matter. For instance, the claimed subject matter may be implemented as a computer-readable medium embedded with a computer executable program, which encompasses a computer program accessible from any computer-readable storage device or storage media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ).

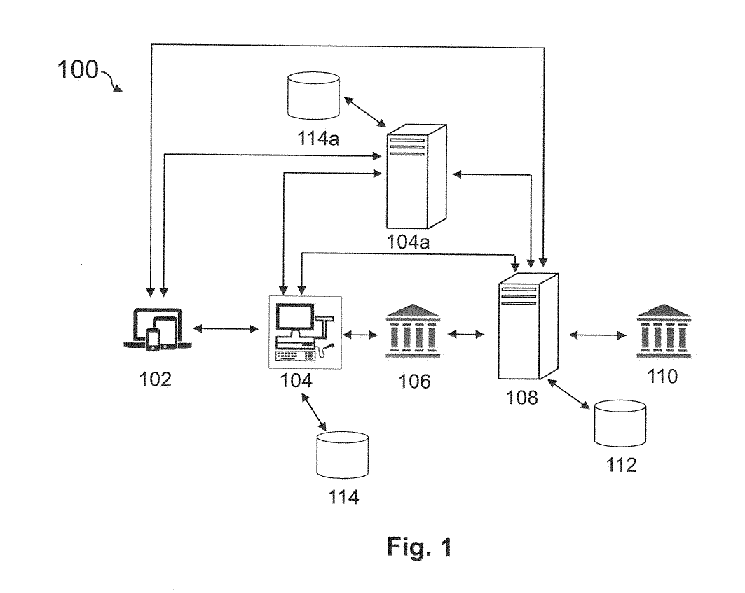

FIG. 1 shows a computer system 100 in accordance with an embodiment of the disclosure. The computer system 100 includes a payment network such as the Banknet payment network operated by Mastercard®. The computer system 100 includes a payment network server 108 operated by a payment network, at least one acquirer server 106, and at least one issuer server 110. The payment network server 108 facilitates fund transfers between a merchant account and a customer account for payment transactions using at least one deposit code. The payment network server 108 is in communication with the acquirer server 106 and the issuer server 110. The acquirer server 106 is operated by an acquiring institution at which the merchant maintains a merchant account to receive/transmit funds. The issuer server 110 is associated with an issuer institution which maintains payment accounts for customers. The issuer server 110 may be associated with electronic service providers which maintain electronic wallets for customers. The computer system 100 further includes a customer electronic device 102 and a merchant apparatus 104 (e.g. a Point-of-Sale (POS) terminal, an Automated Teller Machine (ATM), or a vending machine). The customer electronic device 102 may be one of the following: a mobile phone, a Smartphone, a personal digital assistant (PDA), a key fob, a transponder device, a near field communication (NFC)-enabled device, or a computer. The customer electronic device 102 is in communication with the payment network server 108 and/or a merchant server 104a. The merchant apparatus 104 may be associated with the merchant server 104a. The merchant server 104a may be involved in processing deposit codes as described in more detail below. The merchant apparatus 104 may also be associated with a merchant apparatus database 114 which serves to store a record of transactions carried out at the merchant apparatus 104. In embodiments, the merchant apparatus 104 and the merchant server 104a are in communication with the payment network server 108. Moreover, a payment network database 112 is operationally connected to the payment network server 108 and a merchant database 114a is operationally connected to the merchant server 104a. The payment network database 112 and the merchant database 114a may function as a deposit code database which serves at least to store deposit code information used in processing deposition or payment transactions associated with deposit codes. The role of the deposit code database is described below.

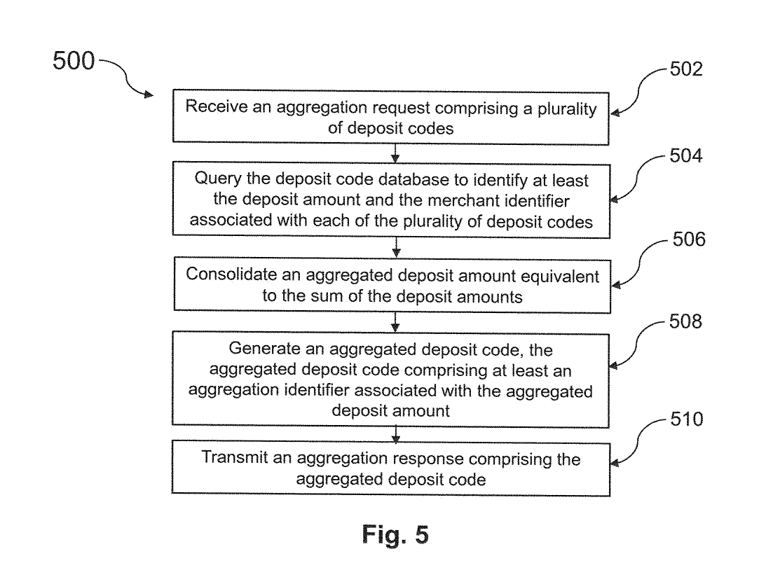

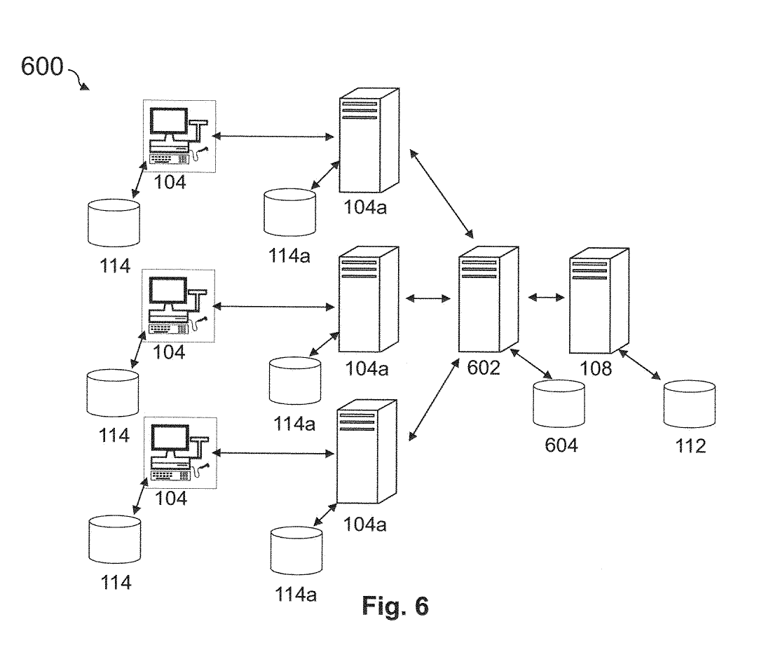

In embodiments, the customer initiates a cash deposit which may include a small denomination of cash, coins, or change at the merchant apparatus 104. The cash deposit may also be made using any denominations, and in any amount, and may involve coins of one or a mixture of currencies. The merchant apparatus 104 includes an input/output module which is configured to receive the cash deposit and calculate a deposit amount indicating an equivalent monetary value of the cash deposited by the customer. The merchant apparatus 104 transmits the deposit amount and a merchant identifier to a deposit server to initiate a deposit request. The deposit request includes the deposit amount and the merchant identifier, the merchant identifier indicating at least a merchant account associated with the merchant apparatus 104. The deposit server may be constituted by one or both of the merchant server 104a and the payment network server 108. For example, when a deposit code issued by merchant A is used in a transaction, it is sufficed that the deposit code is issued by the merchant server 104a associated with merchant A which operates as the deposit server (although in this case, the payment network server may also operate as the deposit server in a similar way). In a scenario where the deposit code issued by merchant A is used to pay for a transaction associated with merchant B, the payment network server 108 may act as a central platform (e.g. by way of Masterpass™) to facilitate transfer of funds between merchant A and merchant B in a conventional way. This may also apply where deposit codes issued by multiple merchants are used for payment of a transaction to e.g. merchant Z. In this case, the payment network server 108 may act as the central platform to facilitate fund transfers from each merchant to merchant Z. In an example where the customer desires to combine a plurality of deposit codes issued at different merchants into a single deposit code (i.e. an aggregated deposit code) via an aggregation process as described in relation to FIG. 5 below, the payment network server 108 or an aggregator server (shown in FIG. 6) operates as the deposit server. In this case, the payment network server 108 or the aggregator server may act as a central server for issuing the aggregated deposit code. In each case, the deposit server 104a, 108 receives the deposit request and generates a deposit code associated with the deposit request, where the deposit code includes at least a deposit identifier associated with the deposit request. The deposit code may be associated with deposit code information which is stored in a deposit code database. The deposit code database may be constituted by one or both of the merchant database 114a and the payment network database 112, depending on which deposit server 104a, 108 processes the deposit request. The deposit code information may include the deposit identifier, the deposit amount and the merchant identifier associated with the deposit request. The deposit code database 114a, 112 may store multiple such deposit code information associated with a plurality of deposit requests. The deposit server 104a, 108 is configured to transmit, to the merchant apparatus 104, the deposit code for exchange with the customer in lieu of the cash deposit. The customer may capture the deposit code using the customer electronic device 102 and may store it in the customer electronic device 102 for future use. A physical copy of the deposit code may be printed using a printing module of the merchant apparatus 104 and may be presented to a customer or merchant for future transactions or deposition.

In some embodiments, the customer initiates a payment transaction request at the merchant apparatus 104 associated with the merchant. The customer may choose to pay for the payment transaction in cash. Typically, the customer may not carry the exact amount for payment of the payment transaction. For example, the customer may pay for an item worth $15.40 using a 50-dollar note. In this scenario, the merchant may use the merchant apparatus 104 of the present disclosure to produce a deposit code as a substitute for cash in lieu of returning change for the payment transaction in cash (e.g. returning $34.60 worth of change either in notes or coins in the above example). To generate the deposit code, the merchant apparatus 104 transmits a deposit amount (e.g. in the above scenario, the deposit amount is $34.60) and a merchant identifier associated with the merchant to a deposit server to initiate a deposit request. Similar processes as described in the preceding paragraph may be performed at the deposit server and the deposit code database to process the deposit request. A deposit code (e.g. in this case equivalent to the monetary amount of $34.60) is transmitted to the merchant apparatus 104 once the deposit request is processed. The customer may capture the deposit code using the customer electronic device 102 and may store it in the customer electronic device 102 for future use. A physical copy of the deposit code may be printed using a printing module of the merchant apparatus 104 and may be presented to the customer for future payment transactions or deposition. In this example, the merchant may also use a combination of cash and a deposit code. For example, the merchant may return to the customer notes in the amount of $34.00 and a deposit code for the amount of $0.60.

After receiving the deposit code from the merchant apparatus 104, the customer may choose to deposit the deposit code into a customer account (e.g. his/her own account or an account of a friend or relative). The customer account maybe a payment account or an electronic wallet. In embodiments, the customer initiates a deposition request associated with a deposition transaction via the customer electronic device 102. The deposition request includes at least the deposit code and a customer identifier associated with the customer account. The customer identifier may be an account number associated with the customer account. In embodiments where the customer account is an electronic wallet, the customer may initiate the deposition request via an electronic wallet application (“App”) on the customer electronic device 102. The customer electronic device 102, via the App, may communicate with the payment network server 108 directly to make the deposition request. Where the deposit server is the merchant server 104a, the customer electronic device 102, via the App, may communicate with the merchant server 104a. The customer may also deposit the deposit code at the merchant apparatus 104 (e.g. an ATM or a POS terminal). In this case, the merchant server 104a may be used to process the deposition request. In either scenario, upon receiving the deposition request, the deposit server 104a, 108 is configured to query the deposit code database 114a, 112 to identify at least the deposit amount and the merchant identifier associated with the deposit code. The deposit server 104a, 108 is configured to request authorization from an acquirer server 106 associated with a merchant account related to the merchant identifier to proceed with the deposition transaction, where the deposition transaction includes transferring funds equal to the deposit amount associated with the deposit code from the merchant account to the customer account. In embodiments where the deposit server processing the deposition request is the merchant server 104a, the merchant server 104a may request authorization via the payment network server 108. Once the deposition transaction has been processed, the deposit server 104a, 108 is configured to transmit, to the customer electronic device 102, a deposition response indicating an approval or a refusal for the deposition transaction.

The customer may choose to use at least one deposit code in a payment transaction. The deposit code(s) may be used in payment transactions associated with merchants who are registered with the deposit server 104a, 108 to process cash deposits in exchange for a deposit code. The customer may use the deposit code(s) in the payment transaction in electronic form(s) and/or physical form(s). In some embodiments, the customer initiates a payment transaction request at the merchant apparatus 104. The input/output module of the merchant apparatus 104 may be configured to receive the at least one deposit code and the merchant apparatus 104 may be configured to transmit the payment transaction request to the deposit server 104a, 108, where the payment transaction request includes the at least one deposit code and a transaction amount. The transaction amount is a monetary amount to be paid by the customer to complete the payment transaction. In some embodiments, the customer initiates a payment transaction request via the App in the customer electronic device 102. In these cases, the payment transaction request includes details of a payee of the payment transaction. Details of the payee may include a name of the payee and/or an account number of the payee. The App in the customer electronic device 102 may communicate the payment transaction request directly to the deposit server 104a, 108. Upon receiving the payment transaction request, the deposit server 104a, 108 is configured to query the deposit code database (the deposit code database may be associated with either the merchant server 104a or the payment network server 108) to identify at least one deposit amount and at least one merchant identifier associated with the at least one deposit code and sort the at least one deposit code according to the at least one deposit amount associated with the at least one deposit code. The deposit server 104a, 108 may process the payment transaction request in either one of the following: (i) determine if a largest deposit amount associated with the at least one deposit code is greater than or equal to the transaction amount, and calculate a transacted deposit amount if the largest deposit amount is greater than or equal to the transaction amount where the transacted deposit amount is the largest deposit amount subtracting the transaction amount, or (ii) determine a sum of the at least one deposit amount such that a largest number of the at least one deposit codes associated with the at least one deposit amount is required for the sum to be greater than or equal to the transaction amount, and calculate a transacted deposit amount where the transacted deposit amount is the sum of the at least one deposit amount subtracting the transaction amount. In any case, the deposit server 104a, 108 is then configured to generate a transacted deposit code which is associated with the transacted deposit amount, and store at least a payment transaction identifier associated with the payment transaction request at the deposit code database 114a, 112. The deposit server 104a, 108 is configured to request authorization from the acquirer server 106 to proceed with the payment transaction, where the payment transaction includes transferring funds equal to the transaction amount from the merchant account associated with the merchant identifier (i.e. the merchant who issued the deposit code for use in the payment transaction) to an appropriate merchant account. In an embodiment where the transaction is initiated at the merchant apparatus 104, the appropriate merchant account is one which is associated with the merchant apparatus 104 at which the payment transaction was initiated. In an embodiment where the transaction is initiated from the customer electronic device 102 via the App, the appropriate merchant account is one which is specified as the payee in the payment transaction request. In some embodiments, the deposit server 104a, 108 is configured to transmit a payment transaction response including a result of the payment transaction request and the transacted deposit code to the merchant apparatus 104, where the transacted deposit code is presented to the customer to complete the payment transaction. Where the payment transaction request is initiated from the customer electronic device 102 via the App, the deposit server 104a, 108 may transmit the payment transaction response to the customer electronic device 102 directly.

For example, a customer may desire to pay merchant B using a deposit code from merchant A. Both merchant A and merchant B may have an electronic wallet (e.g. Masterpass™) provided by the same electronic wallet service provider. In this scenario, after the payment network server 108 (e.g. Mastercard®) has received from the customer the payment transaction request, the payment network server 108 is configured to communicate with the corresponding acquirers of merchant A and merchant B (e.g. requesting authorization from the acquirer of merchant A etc.) so as to facilitate a fund transfer from a merchant A account to a merchant B account. The amount for fund transfer may be associated with a deposit amount associated with the deposit code. If the deposit amount is more than the transaction amount, the deposit server 104a, 108 is configured to calculate a transacted deposit amount where the transacted deposit amount is the deposit amount subtracting the transaction amount. In a scenario where the deposit amount is less than the transaction amount, the deposit server 104a, 108 communicates with the customer via the App to notify the customer that the deposit amount associated with the deposit code is insufficient for paying the payment transaction. The deposit server 104a, 108 may utilize the deposit code by facilitating a transfer of the deposit amount from the merchant A account to the merchant B account, and prompt the customer to use other payment means to pay for a remaining amount, where the remaining amount is an amount equal to the transaction amount subtracting the deposit amount. In the case where the deposit amount is more than the transaction amount, the deposit server 104a, 108 is configured to generate a transacted deposit code which is associated with the transacted deposit amount, and store at least a payment transaction identifier associated with the payment transaction request at the deposit code database 114a, 112. The transacted deposit code may then be transmitted to the customer via the App on the customer electronic device 102 (e.g. in the form of an electronic deposit code) for subsequent use.

Although only one customer electronic device 102 and only one merchant apparatus 104 is shown in FIG. 1, a plurality of customer electronic devices 102 and a plurality of merchant apparatuses 104/merchant servers 104a associated with respective merchants may also be in communication with the payment network server 108, and form part of the computer system 100. Similarly, a plurality of acquirer servers 106 and a plurality of issuer servers 110 may also be in communication with the payment network server 108, and form part of the computer system 100. In other words, the payment network server 108 may act as a central platform for a plurality of merchant apparatuses 104/merchant servers 104a. Therefore, in some embodiments where the payment network server 108 functions as the deposit server, the payment network server 108 acts as a central server for issuing and/or processing deposit codes (e.g. aggregating a plurality of deposit codes) where the deposit requests are received from more than one merchant apparatus 104 or merchant server 104a. In these cases, the payment network database 112 may store deposit code information associated with deposit codes issued by the payment network server 108 (i.e. all deposit code information from a plurality of merchant apparatuses 104/merchant servers 104a). The deposit codes are issued and processed centrally at the payment network server 108 which can reduce administrative burdens on individual merchant to upkeep deposit code information in their individual server/database.

Communication between the servers and databases may take place via any type of network, for example, a virtual private network (VPN), the Internet, a local area and/or wide area network (LAN and/or WAN).

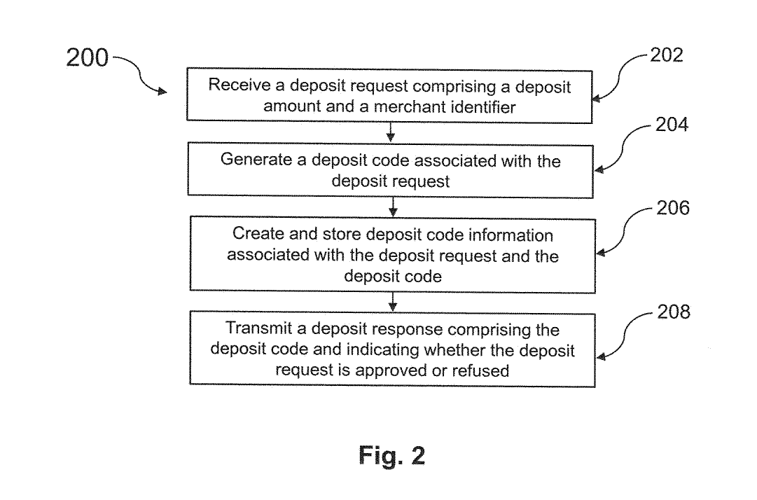

FIG. 2 shows a computer-implemented method 200 which may be performed by the deposit server 104a, 108 for processing a cash deposit in accordance with an embodiment of the present disclosure.

In particular, the deposit server 104a, 108 carrying out the computer-implemented method 200 is configured to:

a) in a step 202, receive, from a merchant apparatus 104, a deposit request, the deposit request including a deposit amount and a merchant identifier, the merchant identifier indicating at least a merchant account associated with a merchant;

b) in a step 204, generate a deposit code associated with the deposit request, wherein the deposit code includes (e.g. stores or embeds within it) at least a deposit identifier associated with the deposit request;

c) in a step 206, create and store deposit code information associated with the deposit request and the deposit code, the deposit code information including the deposit identifier, the deposit amount, and the merchant identifier, wherein the deposit code information is stored in the deposit code database 112, 114a; and

d) in a step 208, transmit, to the merchant apparatus 104, a deposit response to the merchant apparatus 104, the deposit response indicates whether the deposit request is approved or refused and includes at least the deposit code. The deposit response typically indicates an approval and includes at least the deposit code unless operational errors exist during the processing of the above steps.

The deposit identifier is an identifier which can uniquely identify the deposit request and may include a portion or a string of numerals and/or alphanumeric or symbols in any combination. In embodiments, the deposit identifier is used to retrieve associated deposit code information (e.g. the deposit amount and the merchant identifier) when the deposit code is read at the merchant apparatus 104 or at a customer electronic device 102 associated with the customer. The deposit code may include the deposit identifier and the deposit amount, or the deposit identifier and the merchant identifier. In embodiments, the deposit code may include the deposit identifier, the deposit amount, and the merchant identifier. The deposit code may include the merchant identifier and the deposit amount or simply the deposit identifier. The deposit code typically has no expiry date. The deposit code may be a Quick Response (QR) code, a barcode, an EZcode, a high capacity color barcode, a ShotCode, a MaxiCode, a GTIN12 code, a GTIN-13 code, an Aztec code or the like.

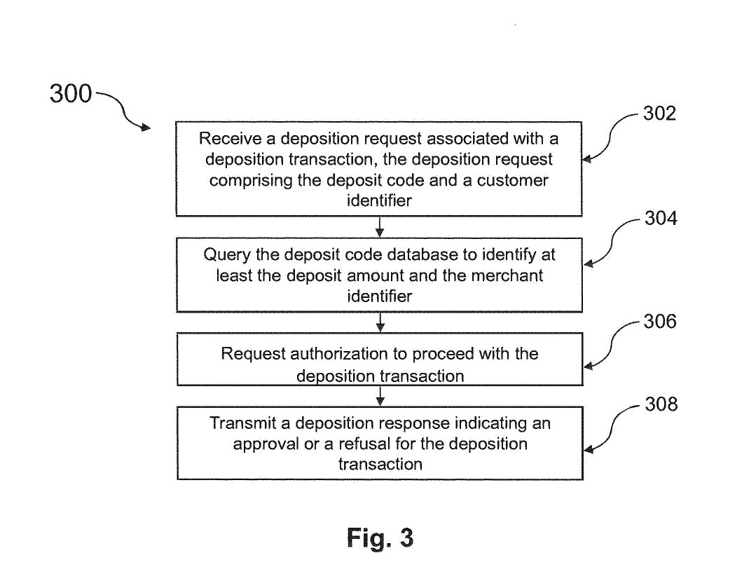

FIG. 2 thus provides a computer-implemented method 200 which allows processing of a cash deposit by converting the cash deposit into a deposit code which is easier for the customer to carry around. The deposit code may be in a digital form which can be stored in the customer electronic device 102, making it more secure and therefore less susceptible to loss (e.g. compared to loose coins which can be easily misplaced). Moreover, the deposit code can be used in an appropriate application (“App”) so that the deposit amount can be refunded or deposited back into a customer account electronically (see e.g. FIG. 3 for more detail). Since the deposit code can be transferred and/or stored in electronic wallets, customer can use the deposit code to support sharing a bill or can transfer an equivalent value of the deposit code to another account (e.g. a friend or merchant) electronically. The use of digital deposit code can also improve customer experience as customers do not have to either be mindful of using coins in future transactions so as to reduce an amount of cash to be carried in coin denominations or to queue in banks to deposit coins.

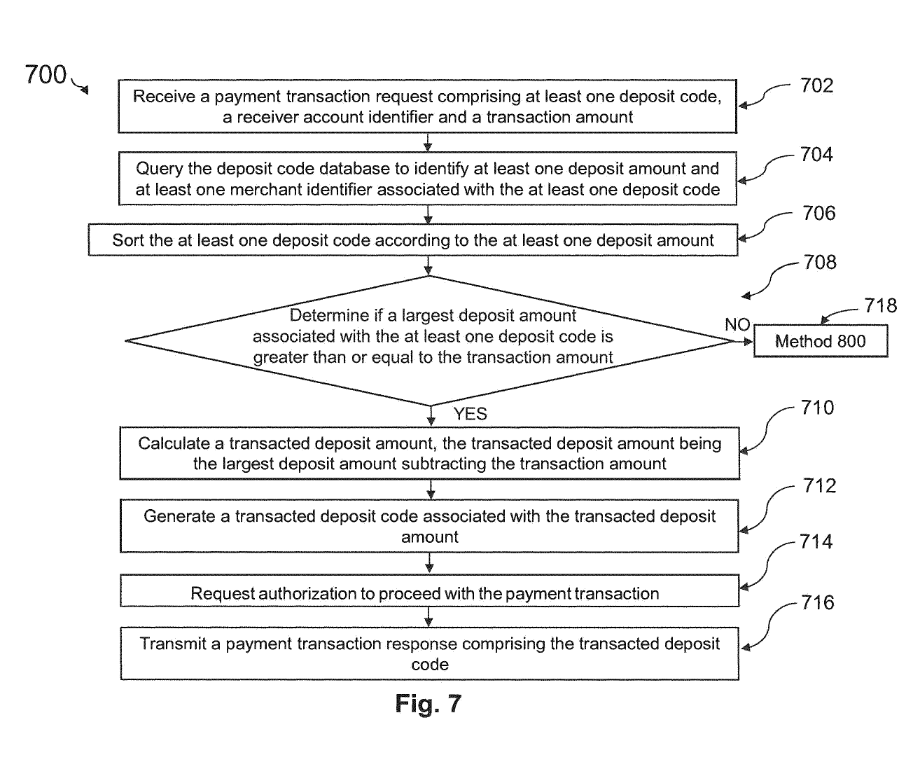

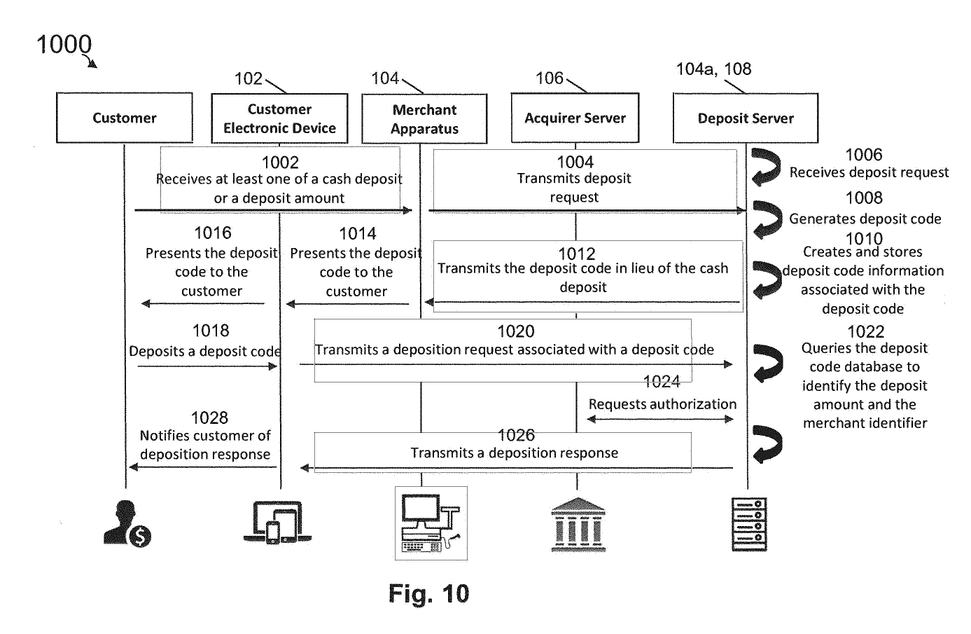

From the view point of a merchant, the conversion of a small denomination of cash into a deposit code is also desirable. For example, the use of deposit code reduces the use of coins, thereby making cash transactions more convenient and improving safety and security for day-to-day operations of the merchant. Deposit codes generated in place of small denominations of change can be more easily tracked and balanced, thereby reducing time and effort for the merchant in keeping track of these small denominations of cash. Moreover, cumulative small denominations of cash deposited at the merchant are retained with the merchant until they are withdrawn by the customers (e.g. either by deposition of deposit codes (see e.g. FIGS. 3 and 10) or through use in payment transactions (see e.g. FIGS. 7-9 and 11)). This provides the merchant with more flexibility in his/her cash flow.

FIG. 3 shows steps of a computer-implemented method 300 for depositing a deposit code in accordance with an embodiment of the disclosure.

In a step 302, the deposit server 104a, 108 is configured to receive a deposition request associated with a deposition transaction from the customer electronic device 102. The deposition request includes at least the deposit code and a customer identifier from a customer electronic device 202.

The customer identifier is an identifier which is uniquely associated with a customer account for use in the deposition transaction. The customer identifier may be a token associated with the customer account, an account number of the customer account, or an identification number of the customer. In embodiments, the customer initiates the deposition request using the “App” in the customer electronic device 102 and the customer is required to sign-in to the “App”. The “App” may be a mobile application which is linked to a customer account (e.g. an electronic wallet). In this case, when the customer initiates the deposition request via the “App”, the “App” may automatically tag the deposition request with the customer identifier which is associated with the customer account. The customer identifier may be used by the deposit server to make the deposition from the merchant account to the customer account.

In a step 304, the deposit server 104a, 108 is configured to query the deposit code database 114a, 112 to identify at least the deposit amount and the merchant identifier associated with the deposit code comprised in the deposition request received in the step 302.

In a step 306, the deposit server 104a, 108 is configured to request authorization to proceed with the deposition transaction from the acquirer server 106. The acquirer server 106 is associated with an acquiring institution which maintains the merchant account. In embodiments, the acquirer server 106 may be identified using the merchant identifier through conventional means known to a skilled person in the art. The deposition transaction includes transferring funds equal to the deposit amount associated with the deposit code from the merchant account to a customer account associated with the customer identifier.

In a step 308, the deposit server 104a, 108 is configured to transmit a deposition response indicating an approval or a refusal for the deposition transaction to the customer electronic device 102. This notifies a result of the deposition transaction to the customer. In embodiments, the deposition transaction may be refused if there is insufficient funds in the merchant account.

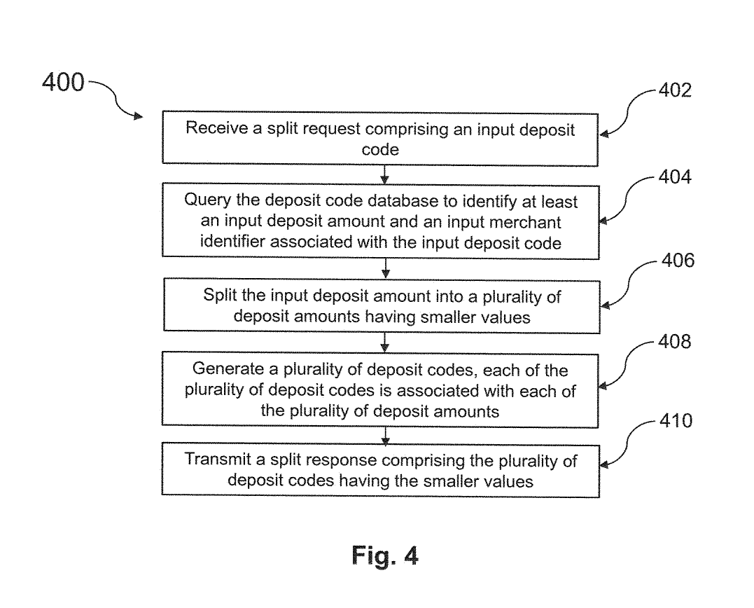

FIGS. 4 and 5 illustrate two different methods for processing deposit code(s) in accordance with embodiments of the disclosure. FIG. 4 illustrates how a single deposit code may be split into a plurality of deposit codes with smaller values, while FIG. 5 illustrates how a plurality of deposit codes may be aggregated to a single deposit code with a larger value.

FIG. 4 shows steps of a computer-implemented method 400 for splitting a deposit code in accordance with an embodiment of the disclosure.

In a step 402, the deposit server 104a, 108 is configured to receive a split request including an input deposit code and instructions to split the input deposit code into smaller values from the merchant apparatus 204. The input deposit code may be presented at the merchant apparatus 204 when the customer wishes to split the input deposit code to a plurality of deposit codes with smaller values. In essence, the input deposit code is no different from any other deposit code except that it is so named to identify it to be the deposit code which is input at the merchant apparatus for performing this split request.

In a step 404, the deposit server 104a, 108 is configured to query the deposit code database 114a, 112 to identify at least an input deposit amount and an input merchant identifier associated with the input deposit code.

In a step 406, the deposit server 104a, 108 is configured to split the input deposit amount into a plurality of deposit amounts having the smaller values, wherein the smaller values together add up to the input deposit amount.

In a step 408, the deposit server 104a, 108 is configured to generate a plurality of deposit codes, wherein each of the plurality of deposit codes is associated with each of the plurality of deposit amounts, and store at least a split identifier associated with the split request. The split identifier may be a portion or a string of numerals or alphanumeric in any combination which can uniquely identify the split request. In embodiments, each of the plurality of deposit codes includes at least a respective deposit amount associated with each of the plurality of deposit amounts and the merchant identifier associated with the input deposit code. Deposit code information such as the split identifier, the plurality of deposit amounts associated with each of the plurality of deposit codes and the merchant identifier associated with each of the plurality of deposit codes may be stored in the deposit code database 114a, 112. The deposit code information may be retrieved from the deposit code database 114a, 112 when each one of the plurality of deposit codes are utilized.

In a step 410, the deposit server 104a, 108 is configured to transmit a split response including the plurality of deposit codes having the smaller values to the merchant apparatus 104.

In embodiments, the method 400 may also be implemented offline using the merchant apparatus 104 by applying a homomorphic encryption algorithm.

FIG. 5 shows steps of a computer-implemented method 500 for aggregating a plurality of deposit codes in accordance with an embodiment of the disclosure. For aggregating a plurality of deposit codes from a single merchant, the method 500 may be performed at either the merchant server 104a (if the plurality of deposit codes are issued by the merchant server 104a) or the payment network server 108. For aggregating a plurality of deposit codes from more than one merchant, the method 500 may be performed using an aggregator server which acts as a central platform for aggregating deposit codes from different merchants. In some embodiments, the aggregator server issues deposit codes by functioning as a deposit server as described previously. In this sense, the aggregator server may function as a central platform for aggregating a plurality of merchants. This is illustrated in FIG. 6 as described below.

In some embodiments, where the plurality of deposit codes are from more than one merchant, the payment network server 108 may also function as the aggregator server while the payment network database 112 may function as the aggregator database as described above. In other words, when the deposit server is the payment network server 108, the deposit server 108 may perform the steps of the method 500 as described below. In some embodiments, where the plurality of deposit codes are from more than one merchant and the deposit server is a merchant server 104a, a separate aggregator server (e.g. a payment network server 108) may be required.

In other words, as discussed above, where the deposit server is the payment network server 108, the deposit server 108 (which may also function as the aggregator server) may perform the method 500 for aggregating a plurality of deposit codes centrally regardless of whether the plurality of merchant codes is associated with more than one merchant or a single merchant. Details of how this works are described together with the steps of the method 500 below.

In a step 502, the deposit server 104a, 108 is configured to receive an aggregation request including a plurality of deposit codes from the merchant apparatus 104. In some embodiments, where the plurality of deposit codes are issued by more than one merchant and the deposit server is the merchant server 104a, the merchant server 104a is configured to forward the aggregation request to the aggregator server (not shown). In some embodiments, the aggregator server may be the payment network server 108 which functions as the aggregator server for the merchant server 104a.

In a step 504, where the plurality of deposit codes are issued by a single merchant associated with the merchant server 104a, the deposit server 104a, 108 is configured to query the deposit code database 114a, 112 to identify at least the deposit amount and the merchant identifier associated with each of the plurality of deposit codes. In some embodiments where the plurality of deposit codes are issued by more than one merchant and the deposit server is the payment network server 108, the payment network server 108 which also functions as the aggregator server is configured to perform the above step. In some embodiments, where the plurality of deposit codes are issued by more than one merchant and the deposit server is the merchant server 104a, the above step is performed at the aggregator server. In some embodiments, the payment network server 108 may function as the aggregator server in identifying at least the deposit amount and the merchant identifier associated with each of the plurality of deposit codes. In these embodiments, the payment network server 108 may be configured to identify the merchant servers 104a associated with each of the plurality of deposit codes and communicate with each of the associated merchant servers 104a to identify at least the deposit amount associated with each of the plurality of deposit codes. In other embodiments, a separate aggregator server (which is shown in FIG. 6) is used.

In a step 506, where the plurality of deposit codes are issued by a single merchant associated with the merchant server 104a, the deposit server 104a, 108 is configured to consolidate an aggregated deposit amount equivalent to a sum of the deposit amounts associated with the plurality of deposit codes. In some embodiments, where the plurality of deposit codes are issued by more than one merchant and the deposit server is the payment network server 108, the consolidation step 506 is performed at the payment network server 108 as the deposit server 108. In some embodiments, where the plurality of deposit codes are issued by more than one merchant and the deposit server is the merchant server 104a, the consolidation step 506 is performed at the aggregator server. In some embodiments, the payment network server 108 may function as the aggregator server for consolidating the aggregated deposit amount.

In a step 508, where the plurality of deposit codes are issued by a single merchant associated with the merchant server 104a, the deposit server 104a, 108 is configured to generate an aggregated deposit code, wherein the aggregated deposit code includes at least an aggregation deposit identifier associated with the aggregation request and the aggregated deposit amount. In some embodiments, where the plurality of deposit codes are issued by more than one merchant and the deposit server is the payment network server 108, since the payment network server 108 may function as the aggregator server, the above step may be performed at the payment network server 108. In some embodiments, where the plurality of deposit codes are issued by more than one merchant and the deposit server is the merchant server 104a, the aggregated deposit code is generated at the aggregator server where aggregated deposit code information associated with the aggregated deposit code is stored in the aggregator database. In some embodiments, the payment network server 108 and the payment network database 112 may function as the aggregator server and the aggregator database respectively.

In a step 510, where the plurality of deposit codes are issued by a single merchant associated with the merchant server 104a, the deposit server 104a, 108 is configured to transmit an aggregation response including the aggregated deposit code to the merchant apparatus 104. In some embodiments, where the plurality of deposit codes are issued by more than one merchant and the deposit server is the payment network server 108, the above step is performed by the payment network server 108. In some embodiments, where the plurality of deposit codes are issued by more than one merchant and the deposit server is the merchant server 104a, the aggregator server (e.g. the payment network server 108) which has received the aggregation request from the merchant server 104a in the step 502 is configured to generate and transmit the aggregation response to the merchant apparatus 104 via the merchant server 104a.

In embodiments, where the plurality of deposit codes are issued by a single merchant (i.e. the merchant associated with the merchant apparatus 104), the method 500 may also be implemented offline using the merchant apparatus 104 by applying a homomorphic encryption algorithm such that aggregation of a plurality of codes can be done without processing at the deposit server 104a, 108.

FIG. 6 shows a computer system 600 in accordance with an embodiment of the disclosure for aggregating a plurality of deposit codes. In particular, the computer system 600 incorporates an aggregator server 602 and an aggregator database 604 for use in aggregating a plurality of deposit codes which are issued by different merchants. In some embodiments, the aggregator server 602 functions as a deposit server and the aggregator database 604 performs as a deposit code database as described in relation to FIGS. 2 to 5 previously.

The computer system 600 includes a plurality of merchant apparatuses 104 which are operationally connected to a plurality of merchant apparatus databases 114. Each of the merchant apparatuses 104 are in turn associated with a merchant server 104a which is operationally connected to a merchant database 114a as shown in FIG. 6. Each of these components (i.e. the merchant apparatuses 104, the merchant apparatus databases 114, the merchant servers 104a, and the merchant databases 114a) functions as described previously in the computer system 100 of FIG. 1. The main difference in this embodiment as shown in the computer system 600 is that each of the merchant server 104a is associated with the aggregator server 602. In some embodiments, the aggregator server 602 serves as a central platform for aggregating deposit codes from different merchants. The aggregator server 602 is associated with the aggregator database 604 which stores aggregated deposit code information used in processing deposition or payment transactions associated with aggregated deposit codes. The aggregated deposit code information may include aggregated deposit identifiers, aggregated deposit amounts, and merchant identifiers associated with the plurality of deposit codes which are aggregated. In some embodiments, the aggregator server 602 may function as a central platform for issuing deposit codes in place of the merchant servers 104a, where information associated with the deposit codes may be stored in the aggregator database 604. In other words, the aggregator server 602 may be configured to perform the methods 200 to 500. In this case, any deposit requests, deposition requests, split requests or aggregation requests received at the merchant apparatuses 104, which are in turn transmitted to the merchant servers 104a, are transmitted to the aggregator server 602 to be processed using the methods 200 to 500 as described.

The aggregator server 602 may be in communication with the payment network server 108. The payment network server 108 may be associated with relevant acquirer servers 106 (not shown in FIG. 6 for simplicity) and/or issuer servers 110 (not shown in FIG. 6 for simplicity) so as to facilitate fund transfers between the relevant entities (e.g. relevant merchant accounts associated with the relevant financial institutions) when the aggregated deposit codes or deposit codes are used in transactions (e.g. deposition or payment transactions as described above). The payment network database 112 associated with the payment network server 108 may store information related to processing these aggregated deposit codes or deposit codes.

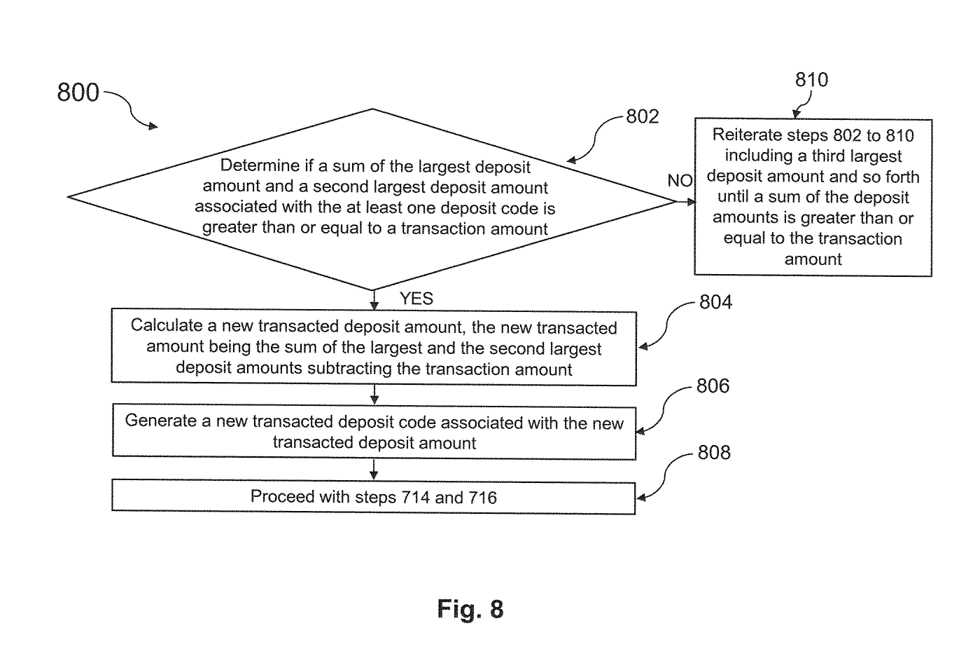

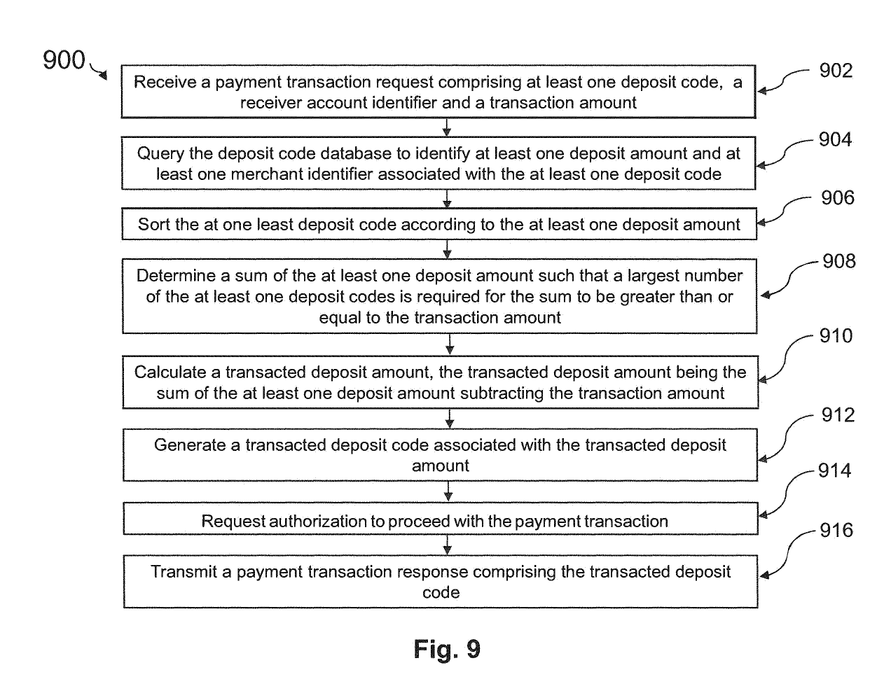

FIGS. 7 to 9 illustrate two different methods for processing payment transaction requests using deposit code(s) in accordance with embodiments of the disclosure. FIGS. 7 and 8 illustrate a method for processing a payment transaction by reducing the number of deposit codes used (e.g. using a deposit code with the largest value first and so forth), while FIG. 9 illustrates a method for processing a payment transaction by maximizing the number of deposit codes used.

FIG. 7 shows steps of a computer-implemented method 700 for processing a payment transaction using a deposit code in accordance with an embodiment of the disclosure.

In a step 702, the deposit server 104a, 108 is configured to receive a payment transaction request including at least one deposit code, a receiver account identifier and a transaction amount from the merchant apparatus 104. The receiver account identifier identifies a receiver account associated with a receiver of the payment transaction. In embodiments, the receiver may be a merchant initiating the payment transaction request.

In a step 704, the deposit server 104a, 108 is configured to query the deposit code database 114a, 112 to identify at least one deposit amount and at least one merchant identifier associated with the at least one deposit code.

In a step 706, the deposit server 104a, 108 is configured to sort the at least one deposit code according to the at least one deposit amount associated with the at least one deposit code.

In a step 708, the deposit server 104a, 108 is configured to determine if a largest deposit amount associated with the at least one deposit code is greater than or equal to the transaction amount.

In a step 710, the deposit server 104a, 108 is configured to calculate a transacted deposit amount if the largest deposit amount is greater than or equal to the transaction amount, the transacted deposit amount being the largest deposit amount subtracting the transaction amount.

In a step 712, the deposit server 104a, 108 is configured to generate a transacted deposit code, wherein the transacted deposit code includes at least a payment transaction identifier associated with the payment transaction request and the transacted deposit amount.

In a step 714, the deposit server 104a, 108 is configured to request authorization to proceed with the payment transaction, wherein the payment transaction includes transferring funds equal to the transaction amount from the merchant account associated with the merchant identifier to the receiver account.

In a step 716, the deposit server 104a, 108 is configured to transmit a payment transaction response including the transacted deposit code to the merchant apparatus 104.

In a step 718, the deposit server 104a, 108 is configured to proceed with a method 800 (discussed below) if it is determined in the step 708 that the largest deposit amount associated with the at least one deposit code is less than the transaction amount.

FIG. 8 shows additional steps of the computer-implemented method 700 of FIG. 7 for processing a payment transaction using a deposit code in accordance with an embodiment of the disclosure. The method 800 provides further steps to the method 700 when it is determined in the step 708 that the largest deposit amount associated with the at least one deposit code is less than the transaction amount.

In a step 802, the deposit server 104a, 108 is configured to determine if a sum of the largest deposit amount and a second largest deposit amount associated with the at least one deposit code is greater than or equal to the transaction amount.

In a step 804, the deposit server 104a, 108 is configured to calculate a new transacted deposit amount if the at least one deposit amount is greater than or equal to the transaction amount, the new transacted deposit amount being the sum of the largest and the second largest deposit amounts subtracting the transaction amount.

In a step 806, the deposit server 104a, 108 is configured to generate a new transacted deposit code, where the new transacted deposit code includes at least a payment transaction identifier associated with the payment transaction request and associated with the new transacted deposit amount.

In a step 808, the deposit server 104a, 108 is configured to proceed with the steps 714 and 716 described in the method 700 where the payment transaction response includes the new transacted deposit code generated in the step 706.

In a step 810, if it is determined that the sum of the largest deposit amount and the second largest deposit amount associated with the at least one deposit code is less than the transaction amount, the server 104a, 108 is configured to repeat the steps in the method 800 additionally using a third largest deposit amount and so forth until a sum of the deposit amounts (e.g. the largest amount, the second largest amount, the third largest amount, etc.) is greater than or equal to the transaction amount.

FIG. 9 shows steps of a computer-implemented method 900 for processing a payment transaction using a deposit code in accordance with an embodiment of the disclosure.

In a step 902, the deposit server 104a, 108 is configured to receive a payment transaction request including at least one deposit code, a receiver account identifier, and a transaction amount from the merchant apparatus 104. As above, the receiver account identifier identifies a receiver account associated with a receiver of the payment transaction. In embodiments, the receiver may be a merchant initiating the payment transaction request.

In a step 904, the deposit server 104a, 108 is configured to query the deposit code database to identify at least one deposit amount and at least one merchant identifier associated with the at least one deposit code.

In a step 906, the deposit server 104a, 108 is configured to sort the at least one deposit code according to the at least one deposit amount associated with the at least one deposit code.

In a step 908, the deposit server 104a, 108 is configured to determine a sum of the at least one deposit amount such that a largest number of the at least one deposit codes associated with the at least one deposit amount is required for the sum to be greater than or equal to the transaction amount.

In a step 910, the deposit server 104a, 108 is configured to calculate a transacted deposit amount, the transacted deposit amount being the sum of the at least one deposit amount subtracting the transaction amount.

In a step 912, the deposit server 104a, 108 is configured to generate a transacted deposit code, wherein the transacted deposit code includes at least a payment transaction identifier associated with the payment transaction request and associated with the transacted deposit amount.

In a step 914, the deposit server 104a, 108 is configured to request authorization to proceed with the payment transaction, wherein the payment transaction includes transferring funds equal to the transaction amount from the merchant account associated with the merchant identifier to the receiver account.

In a step 916, the deposit server 104a, 108 is configured to transmit a payment transaction response including the transacted deposit code to the merchant apparatus 104.

In embodiments where the transaction amount is greater than the largest deposit amount and/or greater than the sum of a plurality of deposit amounts, the deposit amount or plurality of deposit amounts may be deducted from the transaction amount and a balance amount transmitted to the merchant apparatus for settlement by the customer using another form of payment.

FIG. 10 shows steps of a method 1000 for making a cash deposit of, for example, a small denomination of coins and for requesting deposition of a deposit code in accordance with an embodiment of the disclosure. In embodiments, a merchant account is maintained at an acquirer institution associated with the acquirer server 106. As shown in FIG. 10, processing steps 1006, 1008, 1010, and 1022 may be carried out at the payment network server 108 or at the merchant server 104a. In the case where the processing steps are carried out at the merchant server 104a, requesting authorization from the acquirer server 106 at a step 1024 may be carried out via the payment network server 108.

The customer initiates a cash deposit comprising, for example, a small denomination of cash at the merchant apparatus 104 in a step 1002. The cash deposit may involve coins of one or a mixture of currencies. The merchant apparatus 104 includes an input/output module which may be configured to receive the cash deposit and calculate a deposit amount indicating an equivalent monetary value of the cash deposited by the customer. In a step 1004, the merchant apparatus 104 is configured to transmit the deposit amount and a merchant identifier to the deposit server 104a, 108 to initiate a deposit request. The deposit request includes the deposit amount and the merchant identifier, the merchant identifier indicating at least a merchant account associated with the merchant apparatus. The deposit server 104a, 108 is configured to receive the deposit request in a step 1006 and to generate a deposit code associated with the deposit request in a step 1008, where the deposit code includes at least a deposit identifier associated with the deposit request. In a step 1010, the deposit server 104a, 108 is configured to create and store deposit code information associated with the deposit code generated in the step 1008 in the deposit code database 114a, 112. The deposit code database 114a, 112 may be the merchant database 114a or the payment network database 112 depending on which deposit server processes the deposit request. The deposit code information may include the deposit identifier, the deposit amount, and the merchant identifier associated with the deposit request. The deposit code database 114a, 112 may store multiple such deposit code information associated with a plurality of deposit requests. In a step 1012, the server 104a, 108 is configured to transmit, to the merchant apparatus 104, the deposit code for exchange with the customer in lieu of the cash deposit. In embodiments, the step 1012 may be carried out as soon as the deposit code is generated in the step 1008. As such, the step 1012 may be carried out simultaneously with the step 1010 or one after the other or in any combination. In a step 1014, the deposit code received at the merchant apparatus 104 is presented to the customer. The customer may capture the deposit code using the customer electronic device 102 and store it in the customer electronic device 102 for future use, in a step 1016. A physical copy of the deposit code may be printed using a printing module of the merchant apparatus 104 and may be presented to the customer for future transactions or deposition.

After receiving the deposit code from the merchant apparatus 104, the customer may choose to deposit the deposit code into a customer account. The customer account may be a payment account or an electronic wallet. In embodiments, the customer initiates a deposition request associated with a deposition transaction via the customer electronic device 102 in a step 1018. The deposition request is transmitted to the deposit server 104a, 108 for processing in a step 1020. The deposition request includes at least the deposit code and a customer identifier associated with the customer account. The customer identifier may be an account number associated with the customer account. In embodiments where the customer account is an electronic wallet, the customer may initiate the deposition request via an electronic wallet application (“App”) on the customer electronic device 102. The customer electronic device 102, via the App, may communicate with the payment network server 108 directly to make the deposition request. The customer may also deposit the deposit code at the merchant apparatus 104 (e.g. an ATM or a POS terminal). In this case, the merchant server 104a may be used to process the deposition request. In either scenario, upon receiving the deposition request, the deposit server 104a, 108 is configured to query the deposit code database 114a, 112 to identify at least the deposit amount and the merchant identifier associated with the deposit code in a step 1022. The deposit server 104a, 108 is configured to request authorization from the acquirer server 106 associated with the merchant account identified by the merchant identifier to proceed with the deposition transaction in a step 1024, where the deposition transaction includes transferring funds equal to the deposit amount associated with the deposit code from the merchant account to the customer account. In embodiments where the deposit server 104a, 108 processing the deposition request is the merchant server 104a, the merchant server 104a may request authorization via the payment network server 108. Once the deposition transaction has been processed, the deposit server 104a, 108 is configured to transmit a deposition response indicating an approval or a refusal for the deposition transaction to the customer electronic device 102 in a step 1026. The customer may be notified via the customer electronic device 102 in a step 1028.

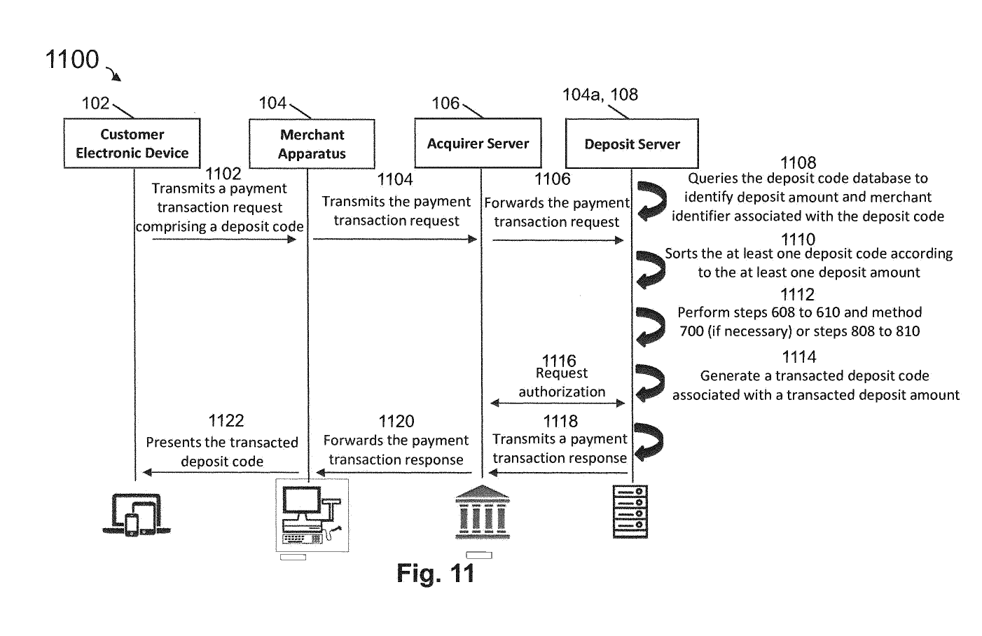

FIG. 11 shows steps of a method 1100 for performing a payment transaction using a deposit code in accordance with an embodiment of the disclosure. Typically, a customer may initiate a payment transaction at a merchant apparatus 104 in a retail location associated with a merchant. The merchant apparatus 104 may be a Point-of-Sale (POS) terminal. The merchant apparatus 104 may be configured to interact with a customer electronic device 102 connected to the computer system 100 as shown in FIG. 1. As shown in FIG. 11, processing steps 1108, 1110, 1112, and 1114 may be carried out at the payment network server 108 or at the merchant server 104a. In the case where the processing steps are carried out at the merchant server 104a, requesting authorization from the acquirer server 106 at a step 1114 may be carried out via the payment network server 108.

The customer may choose to use at least one deposit code in a payment transaction. The deposit code(s) may be used in payment transactions at a merchant apparatus 104 associated with a merchant who is registered with the deposit server 104a, 108 to process cash deposits in exchange for a deposit code. The customer may use the deposit code(s) for the payment transaction in electronic form(s) and/or physical form(s). In embodiments, the customer initiates a payment transaction request at the merchant apparatus 104. The customer may initiate the payment transaction request at the merchant apparatus 104 via the customer electronic device 102 in a step 1102, where the deposit code(s) are in electronic form. The input/output module of the merchant apparatus 104 may be configured to receive the at least one deposit code. In a step 1104, the merchant apparatus 104 is configured to transmit the transaction request to the acquirer server 106, where the payment transaction request includes the at least one deposit code and a transaction amount, the transaction amount being a monetary amount to be paid by the customer to complete the payment transaction. The payment transaction request is in turn forwarded to the deposit server 104a, 108 by the acquirer server 106 in a step 1106. Upon receiving the payment transaction request, the deposit server 104a, 108 is configured to query the deposit code database (the deposit code database may be associated with either the merchant server 104a or the payment network server 108) to identify at least one deposit amount and at least one merchant identifier associated with the at least one deposit code in a step 1108. The deposit server 104a, 108 is then configured to sort the at least one deposit code according to the at least one deposit amount in a step 1110. In a step 1112, the deposit server 104a, 108 may either perform the steps 708 to 710 and if necessary, the method 800; or perform the steps 908 to 910 in the method 900. In other words, the deposit server 104a, 108 may process the payment transaction request in either one of the following: (i) determine if a largest deposit amount associated with the at least one deposit code is greater than or equal to the transaction amount, and calculate a transacted deposit amount if the largest deposit amount is greater than or equal to the transaction amount where the transacted deposit amount is the largest deposit amount subtracting the transaction amount, or (ii) determine a sum of the at least one deposit amount such that a largest number of the at least one deposit codes associated with the at least one deposit amount is required for the sum to be greater than or equal to the transaction amount, and calculate a transacted deposit amount where the transacted deposit amount is the sum of the at least one deposit amount subtracting the transaction amount. In other embodiments, where the transaction amount is greater than the largest deposit amount and/or greater than the sum of a plurality of deposit amounts, the deposit amount or plurality of deposit amounts may be deducted from the transaction amount and a balance amount transmitted to the merchant apparatus for settlement by the customer using another form of payment. In any case, the deposit server 104a, 108 is configured to generate a transacted deposit code which is associated with the transacted deposit amount in a step 1114. The transacted deposit code may store at least a payment transaction identifier associated with the payment transaction request. The deposit server 104a, 108 is configured to request authorization from the acquirer server 106 to proceed with the payment transaction in a step 1116. In embodiments where the steps 1108 to 1114 are processed at the merchant server 104a, the merchant server 104a requests authorization from the acquirer server 106 via the payment network server 108. The payment transaction includes transferring funds equal to the transaction amount (or the sum of the deposit amounts, if these are less than the transaction amount) from the merchant account associated with the merchant identifiers to an appropriate merchant account associated with the merchant apparatus 104 at which the payment transaction was initiated (i.e. the receiver account). In a step 1118, the deposit server 104a, 108 is configured to transmit a payment transaction response including a result of the payment transaction request (including any balance amount still due) and the transacted deposit code to the acquirer server 106 which in turn forwards the payment transaction response to the merchant apparatus 104 in a step 1120. The transacted deposit code is then presented to the customer (or via the customer electronic device 102) to complete the payment transaction via the deposit code, in a step 1122.

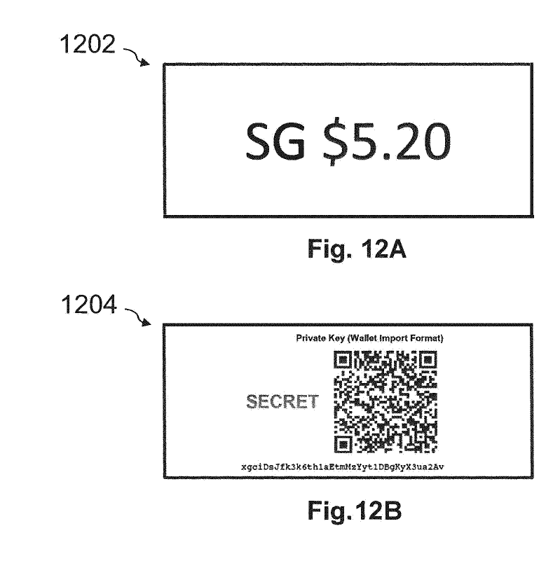

FIG. 12, including FIG. 12A and FIG. 12B, depicts illustrations of a physical copy of a receipt including a deposit code, where FIG. 12A shows a front of the receipt with a value of the deposit code and FIG. 12B shows a rear of the receipt including the deposit code.

In embodiments, the deposit code may store a secret amount which represents the actual monetary amount that has been deposited at the merchant apparatus 104 to generate the deposit code. The deposit code may not be related to any particular customer. In other words, the deposit code may be used as a form of currency and be transferred to anyone. As illustrated in the methods 1000 and 1100 above, the deposit code may be verified by the deposit server 104a, 108 when it is used in deposition and/or payment transactions. Although the deposit code is shown as a QR-code in FIG. 12b, the deposit code may be in the form of a barcode, an EZcode, a high capacity color barcode, a ShotCode, a MaxiCode, a GTIN12 code, a GTIN-13 code, an Aztec code or the like. While embodiments have been described where the deposit code is a machine readable code, the deposit code may also be provided in any other suitable forms of encoded date. For example, the deposit identified, and other information, may also be encoded and transmitted/received using wireless communication protocols, such as Bluetooth, Bluetooth low energy, NFC, Wi-Fi, or any other suitable wireless communication protocol.

Some examples of using the systems and methods of the present disclosure are discussed below.

In an example, a customer makes a request to deposit a plurality of coins into an input/output module of the merchant apparatus 104. The merchant apparatus prints out a physical copy of a deposit code (e.g. a QR-code) associated with the request. The customer may scan the deposit code using a customer electronic device 102 by utilizing a specific mobile application (“App”). Upon scanning the deposit code, a monetary value associated with the plurality of cash deposited may be transferred to a customer account associated with the customer (e.g. an electronic wallet associated with the App). The customer may select from a menu of the App to transfer money to a designated payee in a conventional way. In embodiments, the transfer of money from the customer account includes overseas accounts.

In another example, the customer makes a payment transaction request at a cashier of a merchant where the customer pays $21.00 for a product which costs $20.20. The cashier, using the merchant apparatus 104 of the present disclosure, prints a receipt with a deposit code (e.g. a QR-code) showing $0.80 (similar to the one shown in FIGS. 12A and 12B). Accordingly, the customer may scan the deposit code of $0.80 into the App and store the money in the customer account, use the deposit code to make a purchase via another merchant apparatus 104 or pass the deposit code to another individual as a form of payment.

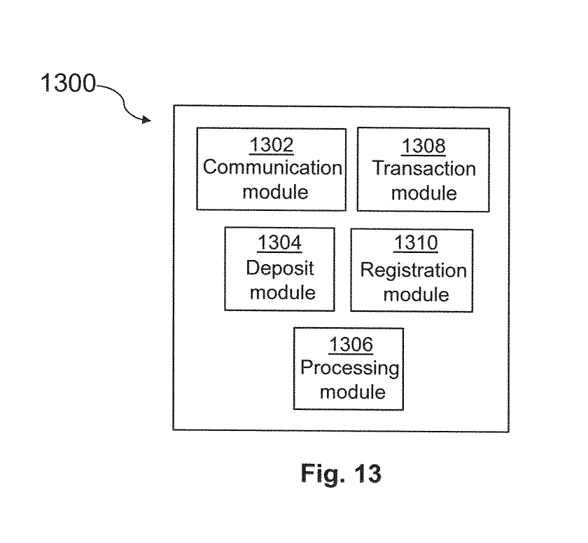

FIG. 13 shows schematically a structure 1300 of a deposit server 104a, 108 included in the computer system 100 in accordance with embodiments of the disclosure. The structure 1300 of the deposit server 104a, 108 includes a communication module 1302, a deposit module 1304, a processing module 1306, a transaction module 1308, and a registration module 1310.

The communication module 1302 may be configured to enable the deposit server 104a, 108 to communicate with at least the merchant apparatus 104 included in the computer system 100. The communication module 1302 may be configured to receive a deposit request including a deposit amount and a merchant identifier from the merchant apparatus 104 (see e.g. the step 202) and to transmit a deposit response including at least the deposit code and indicating whether the deposit request is approved or refused to the merchant apparatus 104 (see e.g. the step 208). The communication module 1302 may be configured to receive a deposition request associated with a deposition transaction where the deposition request includes the deposit code from the customer electronic device 102 (e.g. in the step 302), and to transmit a deposition response indicating an approval or a refusal for the deposition transaction to the customer electronic device 102 (e.g. in the step 308). For processing a split request (e.g. the method 400), the communication module 1302 may be configured to receive a split request including an input deposit code and instructions to split the input deposit code into smaller values from the customer electronic device 102 or the merchant apparatus 104 (e.g. in the step 402), and to transmit a split response including a result of the split request to the customer electronic device 102 or the merchant apparatus 104 (e.g. in the step 410). For processing an aggregation request (e.g. the method 500), the communication module 1302 may be configured to receive an aggregation request including a plurality of deposit codes from the customer electronic device 102 or the merchant apparatus 104 (e.g. in the step 502), and to transmit an aggregation response including a result of the aggregation request to the customer electronic device 102 or the merchant apparatus 104 (e.g. in the step 510). For processing a payment transaction, the communication module 1302 may be configured to receive a payment transaction request including at least one deposit code, a receiver account identifier and a transaction amount from the merchant apparatus 104 via the acquirer server 106 (e.g. in the steps 702 and 902), and to transmit a payment transaction response including a result of the payment transaction request to the merchant apparatus 104 via the acquirer server 106 (e.g. in the steps 702 and 902). The communication module 1302 may be configured to work in tandem with other modules of the deposit server 104a, 108 as discussed in more detail below.

The deposit module 1304 may be configured to allow the deposit server 104a, 108 to generate a deposit code associated with the deposit request, where the deposit code includes at least a deposit identifier associated with the deposit request (e.g. in the step 204), and to request authorization from an acquirer server 106 to proceed with the deposition transaction which includes transferring funds equal to the deposit amount associated with the deposit code from the merchant account to a customer account associated with the customer (e.g. in the step 306).

The processing module 1306 may be configured to create deposit code information associated with the deposit request and store the deposit code information at the payment network database 112 via the communication module 1302 (e.g. in the step 206). The processing module 1306 may be configured to query the deposit code database 112 to identify at least the deposit amount and the merchant identifier (e.g. in the steps 304, 404, 504, 704, 904, etc.). In a process to split a deposit code into a plurality of deposit codes of smaller values (e.g. in the method 400), the processing module 1306 may be configured to split the input deposit amount into a plurality of deposit amounts having the smaller values and to generate a plurality of deposit codes, where each of the plurality of deposit codes is associated with each of the plurality of deposit amounts, and store at least a split identifier associated with the split request. In a process to aggregate a plurality of deposit codes into one deposit code (e.g. in the method 500), the processing module 1306 may be configured to consolidate an aggregated deposit amount equivalent to a sum of the deposit amounts associated with the plurality of deposit codes, and to generate an aggregated deposit code where the aggregated deposit code includes at least an aggregation deposit identifier associated with the aggregation request and associated with the aggregated deposit amount. In the method 700 to reduce the number of deposit codes used for processing a payment transaction, the processing module 1306 may be configured to sort the at least one deposit code according to the at least one deposit amount associated with the at least one deposit code, to determine if a largest deposit amount associated with the at least one deposit code is greater than or equal to the transaction amount, and to calculate a transacted deposit amount if the largest deposit amount is greater than or equal to the transaction amount where the transacted deposit amount being the largest deposit amount subtracting the transaction amount. In the method 800, the processing module 1306 may be configured to determine if a sum of the largest deposit amount and a second largest deposit amount associated with the at least one deposit code is greater than or equal to the transaction amount and to calculate a new transacted deposit amount if the at least one deposit amount is greater than or equal to the transaction amount where the new transacted deposit amount being the sum of the largest and the second largest deposit amounts subtracting the transaction amount. In the method 900 to maximize the number of deposit codes used in processing a payment transaction, the processing module 1306 may be configured to determine a sum of the at least one deposit amount such that a largest number of the at least one deposit codes associated with the at least one deposit amount is required for the sum to be greater than or equal to the transaction amount, and to calculate a transacted deposit amount, the transacted deposit amount being the sum of the at least one deposit amount subtracting the transaction amount. In the methods 700, 800, and 900, the processing module 1306 may be configured to generate a transacted deposit code where the transacted deposit code includes at least a payment transaction identifier associated with the payment transaction request and associated with the transacted deposit amount or the new transacted amount.

The transaction module 1308 may be configured to request, via the communication module 1302, authorization to proceed with the payment transaction, where the payment transaction includes transferring funds equal to the transaction amount from the merchant account associated with the merchant identifier to a receiver account.

The registration module 1310 may be configured to accept registration from customers and/or merchants for processing a cash deposit in exchange for a deposit code. For example, the registration module 1310 receives a registration request via the customer electronic device 102 to deposit small denominations of cash in a customer account associated with the customer. The merchant and its associated acquirer institution may be required to register with a payment network server 108 so that funds associated with deposit codes processed (e.g. for depositions or for payment transactions) either at the merchant server 104a or the payment network server 108 may be transferred to and/or from the merchant account maintained at the acquirer institution. Similarly, the customer and his/her associated issuer institution may be required to register with a payment network server 108 so that funds associated with deposit codes processed (e.g. for depositions or for payment transactions) either at the merchant server 104a or the payment network server 108 may be transferred to and from the customer account maintained at the issuer institution. Although details of registration are not discussed, it would be apparent to a skilled person in the art what would be required to register customers and/or merchants to services provided by acquirer institutions, issuer institutions, and/or the payment network.

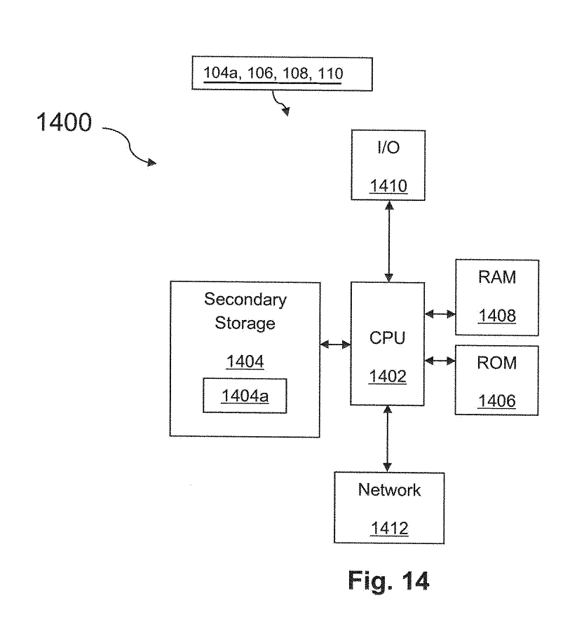

FIG. 14 is a block diagram showing a technical architecture 1400 of the deposit server 104a, 108. The issuer server 110 and/or the acquirer server 106 may also have this technical architecture. The merchant apparatus 104 may also have similar technical architecture.

The technical architecture 1400 includes a processor 1402 (which may be referred to as a central processor unit or CPU) that is in communication with memory devices including secondary storage 1404 (such as disk drives), read only memory (ROM) 1406, and random access memory (RAM) 1408. The processor 1402 may be implemented as one or more CPU chips. The technical architecture may further include input/output (I/O) devices 1410, and network connectivity devices 1412.

The secondary storage 1404 typically includes one or more disk drives or tape drives and is used for non-volatile storage of data and as an over-flow data storage device if RAM 1408 is not large enough to hold all working data. Secondary storage 1404 may be used to store programs which are loaded into RAM 1408 when such programs are selected for execution.

In this embodiment, the secondary storage 1404 has a processing component 1404a including non-transitory instructions operative by the processor 1402 to perform various operations of the method of the present disclosure. The ROM 1406 is used to store instructions and perhaps data which are read during program execution. The secondary storage 1404, the RAM 1408, and/or the ROM 1406 may be referred to in some contexts as computer readable storage media and/or non-transitory computer readable media.

I/O devices 1410 may include printers, video monitors, liquid crystal displays (LCDs), plasma displays, touch screen displays, graphic user interfaces (GUIs), keyboards, keypads, switches, dials, mice, track balls, voice recognizers, card readers, paper tape readers, or other input or output devices.

The network connectivity devices 1412 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other network devices. These network connectivity devices 1412 may enable the processor 1402 to communicate with the Internet or one or more intranets. With such a network connection, it is contemplated that the processor 1402 might receive information from the network, or might output information to the network in the course of performing the above-described method operations. Such information, which is often represented as a sequence of instructions to be executed using processor 1402, may be received from and outputted to the network, for example, in the form of a computer data signal embodied in a carrier wave.

The processor 1402 executes instructions, codes, computer programs, scripts which it accesses from hard disk, floppy disk, optical disk (these various disk based systems may all be considered secondary storage 1404), flash drive, ROM 1406, RAM 1408, or the network connectivity devices 1412. While only one processor 1402 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture to provide the functionality of a number of servers that is not directly bound to the number of computers in the technical architecture. In an embodiment, the functionality disclosed above may be provided by executing an application and/or applications in a cloud computing environment. Cloud computing may include providing computing services via a network connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 1402, the RAM 1408, and the ROM 1406 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

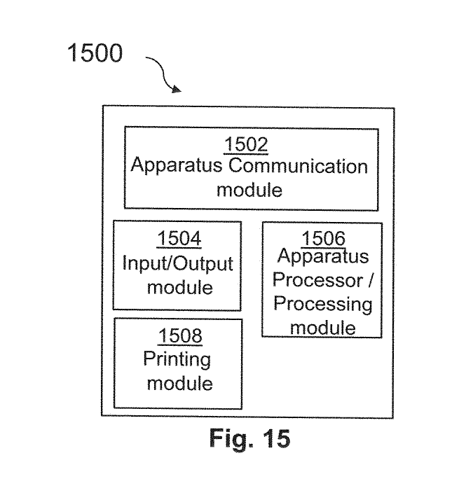

FIG. 15 shows schematically a structure 1500 of the merchant apparatus 104 (e.g. a POS terminal) included in the computer system 100 in accordance with embodiments of the disclosure. The structure 1500 of the merchant apparatus 104 includes an apparatus communication module 1502, an input/output module 1504, an apparatus processor/processing module 1506, and a printing module 1508.

The apparatus communication module 1502 may be configured to enable the merchant apparatus 104 to communicate with at least the customer electronic device 102, the acquirer server 106 and the payment network server 108 as provided in the computer system 100. The apparatus communication module 1502 may be configured to transmit a deposit and a merchant identifier to initiate a deposit request at the deposit server 104a, 108. The apparatus communication module 1502 is configured to work in tandem with other modules of the merchant apparatus 108 as discussed in more detail below.

The input/output module 1504 may be configured to receive at least one of the cash deposit or deposit amount indicating an equivalent monetary value of the cash deposit and to present the deposit code to a customer in exchange for the cash deposit (see e.g. the steps 1002 and 1014). The input/output module 1504 may be configured to (i) receive an input deposit code and instructions to split the input deposit code into smaller values and/or (ii) receive a plurality of deposit codes and instructions to aggregate the plurality of deposit codes. After the split request and/or the aggregation request has been processed, the input/output module 1504 may be configured to present a plurality of deposit codes (for the case of a split request) or an aggregated deposit code (for the case of an aggregation request) to the customer.

The apparatus processor/processing module 1506 of the merchant apparatus 104 may be configured, after the input/output module 1504 receives at least one of the cash deposit or deposit amount, to calculate a deposit amount indicating an equivalent monetary value of the cash deposit when such cash deposit is received. The apparatus processor/processing module 1506 may be configured to transmit, using the apparatus communication module 1502, a deposit request including a deposit amount and a merchant identifier to the deposit server 104a, 108, and to receive a deposit code associated with the deposit request from the deposit server 104a, 108. In processing a split request, the apparatus processor/processing module 1506 may be configured to retrieve, from an input deposit code, at least an input deposit amount and an input merchant identifier associated with the input deposit code; to split the input deposit amount into a plurality of deposit amounts having the smaller values, wherein the smaller values together add up to the input deposit amount, and to generate a plurality of deposit codes, where each of the plurality of deposit codes is associated with each of the plurality of deposit amounts, and store at least the input merchant identifier. The apparatus processor/processing module 1506 may be configured, to work with the apparatus communication module 1502, to transmit the split request including the deposit code, and instructions to split the deposit code into a plurality of deposit codes having smaller values to the deposit server 104a, 108, and to receive a split response including the plurality of deposit codes, wherein each of the plurality of deposit codes stores at least a split identifier associated with the split request from the deposit server 104a, 108. In processing an aggregation request, the apparatus processor/processing module 1506 may be configured, to work with the apparatus communication module 1502, to transmit an aggregation request including a plurality of deposit codes to the deposit server 104a, 108, and to receive an aggregation response including an aggregated deposit code, wherein the aggregated deposit code is associated with a total sum of the plurality of deposit amounts and stores at least an aggregation identifier associated with the aggregation request from the deposit server 104a, 108.

The printing module 1508 may be configured to work with the apparatus processor 1506 to generate physical forms of the deposit code, the plurality of deposit codes having smaller values and/or the aggregated deposit code.

Whilst the foregoing description has described exemplary embodiments, it will be understood by those skilled in the art that many variations of the embodiments can be made within the scope of the present disclosure as defined by the claims. Moreover, features of one or more embodiments may be mixed and matched with features of one or more other embodiments.

1. A computer system for issuing a deposit code as a substitute for cash, the computer system comprising:
at least one merchant apparatus, each merchant apparatus configured to:
receive, from a customer or a merchant, at least one of a cash deposit and a deposit amount indicating an equivalent monetary value of the cash deposit; and
transmit a deposit request, the deposit request comprising the deposit amount and a merchant identifier, the merchant identifier indicating at least a merchant account associated with the merchant apparatus;
a deposit code database configured to store deposit code information associated with multiple such deposit requests, the deposit code information comprising a deposit identifier, the deposit amount, and the merchant identifier; and
a deposit server configured to:
receive the deposit request;
generate a deposit code associated with the deposit request, wherein the deposit code comprises at least the deposit identifier associated with the deposit request;
store, in the deposit code database, the deposit code information associated with the deposit code; and
transmit, to the merchant apparatus, the deposit code for exchange with the customer in lieu of the cash deposit.

2. The system according to claim 1, wherein the at least one merchant apparatus comprises:
an input/output module configured to:
receive the at least one of the cash deposit and the deposit amount; and
present, to the customer, the deposit code in exchange for the cash deposit; and
at least one apparatus processor configured to:
calculate the deposit amount indicating the equivalent monetary value of the cash deposit when such cash deposit is received;
transmit, to the deposit server, the deposit request comprising the deposit amount and the merchant identifier; and
receive, from the deposit server, the deposit code associated with the deposit request.

3. The system according to claim 2 wherein the input/output module of the at least one merchant apparatus is further configured to:
receive an input deposit code, and instructions to split the input deposit code into a plurality of deposit codes, each of smaller value than the input deposit code; and
present, to the customer, the plurality of deposit codes; and
wherein the at least one apparatus processor of the merchant apparatus is further configured to:
retrieve, from the input deposit code, at least an input deposit amount and an input merchant identifier associated with the input deposit code;
split the input deposit amount into a plurality of deposit amounts having the smaller values, wherein the smaller values together add up to the input deposit amount; and
generate the plurality of deposit codes, wherein each of the plurality of deposit codes is associated with a respective deposit amount of the plurality of deposit amounts and at least the input merchant identifier.

4. The system according to claim 2, wherein the input/output module of the at least one merchant apparatus is further configured to:
receive an input deposit code, and instructions to split the input deposit code into a plurality of deposit codes, each of smaller value than the input deposit code; and
present, to the customer, the plurality of deposit codes; and
wherein the at least one apparatus processor of the merchant apparatus is further configured to:
transmit, to the deposit server, a split request comprising the input deposit code, and instructions to split the input deposit code into a plurality of deposit amounts having smaller values that together add up to a value of the input deposit code; and
receive, from the deposit server, a split response comprising the plurality of deposit codes, wherein a respective deposit amount of the plurality of deposit codes is associated with each of the plurality of deposit amounts and at least a split identifier associated with the split request.

5. The system according to claim 2, wherein the input/output module of the at least one merchant apparatus is further configured to:
receive a plurality of deposit codes; and
present, to the customer, an aggregated deposit code; and
wherein the at least one apparatus processor of the at least one merchant apparatus is further configured to:
transmit, to the deposit server, an aggregation request comprising the plurality of deposit codes, the aggregation request being a request to consolidate a plurality of deposit amounts associated with the plurality of deposit codes; and
receive, from the deposit server, an aggregation response comprising an aggregated deposit code, wherein the aggregated deposit code is associated with a total sum of the plurality of deposit amounts and at least an aggregation identifier associated with the aggregation request.

6. The system according to claim 2, wherein the at least one merchant apparatus further comprises a printing module, wherein the at least one apparatus processor is further configured to generate, together with the printing module, physical forms of the deposit code, the plurality of deposit codes having at least one of smaller values and the aggregated deposit code.

7. A deposit server for issuing a deposit code as a substitute for cash, the deposit server comprising a processor configured to:
receive, from a merchant apparatus, a deposit request, the deposit request comprising a deposit amount and a merchant identifier, the merchant identifier indicating at least a merchant account associated with a merchant;
generate a deposit code associated with the deposit request, wherein the deposit code comprises at least a deposit identifier associated with the deposit request;
create and store deposit code information associated with the deposit request and the deposit code, the deposit code information comprising the deposit identifier, the deposit amount, and the merchant identifier, wherein the deposit code information is stored in a deposit code database; and
transmit a deposit response to the merchant apparatus; wherein the deposit response comprises at least the deposit code.

8. The deposit server according to claim 7, further configured to:
receive, from a customer electronic device associated with a customer, a deposition request associated with a deposition transaction, the deposition request comprising the deposit code and a customer identifier associated with the customer;
query the deposit code database to identify at least the deposit amount and the merchant identifier;
request authorization from an acquirer server associated with the merchant identifier to proceed with the deposition transaction, wherein the deposition transaction comprises transferring funds equal to the deposit amount associated with the deposit code from the merchant account to a customer account associated with the customer identifier; and
transmit, to the customer electronic device, a deposition response indicating an approval or a refusal for the deposition transaction.

9. The deposit server according to claim 7, further configured to:
receive a split request comprising an input deposit code, and instructions to split the input deposit code into a plurality of deposit codes, each of smaller value than the input deposit code;
query the deposit code database to identify at least an input deposit amount and an input merchant identifier associated with the input deposit code;
split the input deposit amount into a plurality of deposit amounts having the smaller values, wherein the smaller values together add up to the input deposit amount;
generate the plurality of deposit codes, wherein each of the plurality of deposit codes is associated with a respective deposit amount of the plurality of deposit amounts and stores at least a split identifier associated with the split request; and
transmit a split response comprising the plurality of deposit codes having the smaller values.

10. The deposit server according to claim 7, further configured to:
receive an aggregation request comprising a plurality of deposit codes;
query the deposit code database to identify at least the deposit amount and the merchant identifier associated with each of the plurality of deposit codes;
consolidate an aggregated deposit amount equivalent to a sum of the deposit amounts associated with the plurality of deposit codes;
generate an aggregated deposit code, wherein the aggregated deposit code comprises at least an aggregation deposit identifier associated with the aggregation request and the aggregated deposit amount; and
transmit an aggregation response comprising the aggregated deposit code.

11. The deposit server according to claim 7, further configured to:
receive a payment transaction request comprising at least one deposit code, a receiver account identifier, and a transaction amount, wherein the receiver account identifier identifies a receiver account associated with a receiver of the payment transaction;
query the deposit code database to identify at least one deposit amount and at least one merchant identifier associated with the at least one deposit code;
sort the at least one deposit code according to the at least one deposit amount associated with the at least one deposit code;
determine if a largest deposit amount associated with the at least one deposit code is greater than or equal to the transaction amount;
calculate a transacted deposit amount if the largest deposit amount is greater than or equal to the transaction amount, the transacted deposit amount being the largest deposit amount less the transaction amount;
generate a transacted deposit code, wherein the transacted deposit code stores at least a payment transaction identifier associated with the payment transaction request and the transacted deposit amount;
request authorization to proceed with the payment transaction, wherein the payment transaction comprises transferring funds equal to the transaction amount from the merchant account associated with the at least one deposit code to the receiver account; and
transmit a payment transaction response comprising a result of the payment transaction request and the transacted deposit code.

12. The deposit server according to claim 11, wherein when the largest deposit amount is less than the transaction amount, the processor is further configured to:
determine if a sum of the largest deposit amount and a second largest deposit amount associated with the at least one deposit code is greater than or equal to the transaction amount;
calculate a new transacted deposit amount if the at least one deposit amount is greater than or equal to the transaction amount, the new transacted deposit amount being the sum of the largest and the second largest deposit amounts less the transaction amount; and
generate a new transacted deposit code, wherein the new transacted deposit code stores at least a payment transaction identifier associated with the payment transaction request and the new transacted deposit amount, wherein the payment transaction response comprises the new transacted deposit code.

13. The deposit server according to claim 7, further configured to:
receive a payment transaction request comprising at least one deposit code, a receiver account identifier and a transaction amount, wherein the receiver account identifier identifies a receiver account associated with a receiver of the payment transaction;
query the deposit code database to identify at least one deposit amount and at least one merchant identifier associated with the at least one deposit code;
sort the at least one deposit code according to the at least one deposit amount associated with the at least one deposit code;
determine a sum of the at least one deposit amount such that a largest number of the at least one deposit codes associated with the at least one deposit amount is required for the sum to be greater than or equal to the transaction amount;
calculate a transacted deposit amount, the transacted deposit amount being the sum of the at least one deposit amount less the transaction amount;
generate a transacted deposit code, wherein the transacted deposit code stores at least a payment transaction identifier associated with the payment transaction request and the transacted deposit amount;
request authorization to proceed with the payment transaction, wherein the payment transaction comprises transferring funds equal to the transaction amount from the merchant account associated with the at least one deposit code to the receiver account; and
transmit a payment transaction response comprising a result of the payment transaction request and the transacted deposit code.

14. A computer-implemented method for issuing a deposit code as a substitute for cash, the method comprising:
receiving, from a merchant apparatus, a deposit request, the deposit request comprising a deposit amount and a merchant identifier, the merchant identifier indicating at least a merchant account associated with a merchant;
generating a deposit code associated with the deposit request, wherein the deposit code comprises at least a deposit identifier associated with the deposit request;
creating and storing deposit code information associated with the deposit request and the deposit code, the deposit code information comprising the deposit identifier, the deposit amount and the merchant identifier, wherein the deposit code information is stored in a deposit code database; and
transmitting, to the merchant apparatus, a deposit response, the deposit response comprising at least the deposit code for exchange with a customer in lieu of the cash deposit.

15. The method according to claim 14, further comprising:
receiving, from a customer electronic device associated with a customer, a deposition request associated with a deposition transaction, the deposition request comprising the deposit code and a customer identifier associated with the customer;
querying the deposit code database to identify at least the deposit amount and the merchant identifier;
requesting authorization, from an acquirer server associated with the merchant account, to proceed with the deposition transaction, wherein the deposition transaction comprises transferring funds equal to the deposit amount associated with the deposit code from the merchant account to a customer account associated with the customer identifier; and
transmitting, to the customer electronic device, a deposition response indicating an approval or a refusal for the deposition transaction.

16. The method according to claim 14, further comprising:
receiving, from the merchant apparatus, a split request comprising an input deposit code, and instructions to split the input deposit code into smaller values;
querying the deposit code database to identify at least an input deposit amount and an input merchant identifier associated with the input deposit code;
splitting the input deposit amount into a plurality of deposit amounts having the smaller values, wherein the smaller values together add up to the input deposit amount;
generating a plurality of deposit codes, wherein each of the plurality of deposit codes is associated with a respective deposit amount of the plurality of deposit amounts and comprises at least a split identifier associated with the split request; and
transmitting, to the merchant apparatus, a split response comprising the plurality of deposit codes having the smaller values.

17. The method according to claim 14, further comprising:
receiving, from the merchant apparatus, an aggregation request comprising a plurality of deposit codes;
querying the deposit code database to identify at least the deposit amount and the merchant identifier associated with each of the plurality of deposit codes;
consolidating an aggregated deposit amount equivalent to a sum of the deposit amounts associated with the plurality of deposit codes;
generating an aggregated deposit code, wherein the aggregated deposit code stores at least an aggregation deposit identifier associated with the aggregation request and is associated with the aggregated deposit amount; and
transmitting, to the merchant apparatus, an aggregation response comprising the aggregated deposit code.

18. The method according to claim 14, further comprising:
receiving, from the merchant apparatus, a payment transaction request comprising at least one deposit code, a receiver account identifier, and a transaction amount, wherein the receiver account identifier identifies a receiver account associated with a receiver of the payment transaction;
querying the deposit code database to identify at least one deposit amount and at least one merchant identifier associated with the at least one deposit code;
sorting the at least one deposit code according to the at least one deposit amount associated with the at least one deposit code;
determining if a largest deposit amount associated with the at least one deposit code is greater than or equal to the transaction amount;
calculating a transacted deposit amount if the largest deposit amount is greater than or equal to the transaction amount, the transacted deposit amount being the largest deposit amount less the transaction amount;
generating a transacted deposit code, wherein the transacted deposit code comprises at least a payment transaction identifier associated with the payment transaction request and the transacted deposit amount;
requesting authorization to proceed with the payment transaction, wherein the payment transaction comprises transferring funds equal to the transaction amount from the merchant account associated with the at least one deposit code to the receiver account; and
transmitting, to the merchant apparatus, a payment transaction response comprising the transacted deposit code.

19. The method according to claim 18, wherein the largest deposit amount is less than the transaction amount, the method further comprising:
determining if a sum of the largest deposit amount and a second largest deposit amount associated with the at least one deposit code is greater than or equal to the transaction amount;
calculating a new transacted deposit amount if the at least one deposit amount is greater than or equal to the transaction amount, the new transacted deposit amount being the sum of the largest and the second largest deposit amounts less the transaction amount; and
generating a new transacted deposit code, wherein the new transacted deposit code comprises at least a payment transaction identifier associated with the payment transaction request and the new transacted deposit amount, and wherein the payment transaction response comprises the new transacted deposit code.

20. The method according to claim 14, further comprising:
receiving a payment transaction request comprising at least one deposit code, a receiver account identifier, and a transaction amount, wherein the receiver account identifier identifies a receiver account associated with a receiver of the payment transaction;
querying the deposit code database to identify at least one deposit amount and at least one merchant identifier associated with the at least one deposit code;
sorting the at least one deposit code according to the at least one deposit amount associated with the at least one deposit code;
determining a sum of the at least one deposit amount such that a largest number of the at least one deposit codes associated with the at least one deposit amount is required for the sum to be greater than or equal to the transaction amount;
calculating a transacted deposit amount, the transacted deposit amount being the sum of the at least one deposit amount less the transaction amount;
generating a transacted deposit code, wherein the transacted deposit code comprises at least a payment transaction identifier associated with the payment transaction request and the transacted deposit amount;
requesting authorization to proceed with the payment transaction, wherein the payment transaction comprises transferring funds equal to the transaction amount from the merchant account associated with the at least one deposit code to the receiver account; and
transmitting a payment transaction response comprising the transacted deposit code.
